(19) United States
(12) Patent Application Publication
(10) Pub. No.: US 2026/0063526 A1
(43) Pub. Date: Mar. 5, 2026

(54) SYSTEM AND METHODS FOR SENSING THE VIBRATIONS OF EVEN CROSS-SECTIONAL MODES IN A CIRCULAR CYLINDER USING A PAIR OF PIEZOELECTRIC WIRES

(71) Applicant: KING FAHD UNIVERSITY OF PETROLEUM AND MINERALS, Dhahran (SA)

(72) Inventor: Djamel OUIS, Dhahran (SA)

(73) Assignee: KING FAHD UNIVERSITY OF PETROLEUM AND MINERALS, Dhahran (SA)

(21) Appl. No.: 18/829,472

(22) Filed: Sep. 10, 2024

(30) Foreign Application Priority Data
Sep. 2, 2024 (SA) 1020244872

(51) Int. Cl. G01N 3/40; G01N 3/30

(52) U.S. Cl. CPC G01N 3/405; G01N 3/30; G01N 2203/001; G01N 2203/0039; G01N 2203/0218; G01N 2203/0266; G01N 2203/0623; G01N 2203/0688

(57) ABSTRACT

A dual piezoelectric wire sensor system and a method for non-destructive testing of a cylindrical structure utilizes a pair of H-shaped calipers attached to the cylindrical structure at radial positions ninety degrees apart. Each H-shaped caliper includes two arms and a crossbar connected to and perpendicular to the two arms. A caliper connecter is attached to the first ends of each arm. A wire connecter is attached to the second ends of each arm, between which a piezoelectric wire is connected and stretched. An electrical terminal connects one wire connector to a two-port signal subtractor, which receives signals from the two H-shaped calipers and generates a difference signal. A measurement unit, connected to the two-port signal subtractor, receives the difference signal, performs a frequency analysis, identifies a resonant frequency of an ovalling mode and identifies a stiffness value of the cylindrical structure.

### CROSS REFERENCE TO RELATED APPLICATIONS

The present application claims the benefit of priority to Saudi Patent Application No. SA 1020244872, filed on Sep. 2, 2024, which is incorporated herein by reference in its entirety.

The present disclosure is related to U.S. application Ser. No. 18/760,650 titled “Apparatus, System And Method For Sensing The Vibrations Of Even Cross-Sectional Modes In A Circular Cylinder Using A Piezoelectric Wire” filed on Jul. 1, 2024, which is incorporated herein by reference in its entirety.

### BACKGROUND

### Technical Field

The present disclosure is directed to the field of non-destructive testing techniques, and more specifically relates to a system and a method for assessing structural integrity and stiffness of cylindrical structures such as columns, pipes, poles, or tree trunks through vibrational analysis.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In the construction and utility sectors, cylindrical elements such as metal and concrete columns, as well as wooden poles and logs, are widely used. These structures bear significant loads in buildings, bridges, harbor piers, and serve as supports for lamp posts, telephone, and electric power cables. In the wood industry, the quality of lumber, which is processed from logs, depends on the health of the trees. Therefore, assessing the structural integrity and health status of these cylindrical elements before their utilization or processing is required for operational efficiency and effectiveness. The ability to pre-evaluate the condition of these elements can prevent wasteful expenditures of time and resources on unsuitable materials and ensure safety and reliability in their application.

Traditional methods for assessing the health of cylindrical elements, especially in forestry and small to medium-sized wood operations, often rely on rudimentary and subjective techniques. Methods such as tapping wood with a hammer or probing with a screwdriver are not only imprecise but prone to human error, leading to potentially viable wood being discarded due to superficial signs of decay. This approach lacks the reliability and accuracy required for effective decision-making, highlighting the requirement for more sophisticated and objective assessment methods.

Measuring the stiffness of a solid material elongated element by 3-point or cantilever bending tests provides useful information on the material properties of prismatic elements. While 3-point or cantilever bending tests offer insights into material properties for prismatic elements, they are impractical or impossible for cylindrical elements, especially those already integrated into structures or those that are voluminous, such as logs and standing tree trunks. Moreover, applying force to the top of a wooden pole in such tests could pose safety risks to technical personnel, which highlights the requirement for a safer, more efficient method of assessing stiffness and structural integrity elements. Some of these techniques use vibrations or sound, even ultrasound, to excite the wooden element and monitor its response. Others use an electrical voltage applied between two nearby positions on the wood element to measure the electrical resistance between them. Other more elaborate techniques use penetrating X or gamma rays and process a tomogram of the interior of the investigated wood element. In general, most of these methods can only locate rot pockets, that is when the decay stage is so advanced that most of the material has been removed. However, a decay attack even at its incipient stage can have a pronounced destructive effect while it cannot be detected by the naked eye or probed by advanced optical equipment. Decay attacks also result in an elevated rate of moisture content, which makes some of the aforementioned methods more sensitive, and sometimes unreliable when water content affects the variables they measure.

US20150128710A1 describes a system and method for non-destructive monitoring of a component including a guided wave sensor positioned around the surface of the component. The system has first and second mounting clamps that are positioned at 0.1 inches to 5.0 inches on either side of the guided wave sensor. Elongated springs including a first end, a second end, and a central portion are attached at the first end to the first spring mounting clamp and attached at the second end to the second spring mounting clamp and the central portion applies pressure to the guided wave sensor. The system and method may be used for non-destructive monitoring of components such as bridge cables, anchor rods, braces, building components, aircraft structures, pipelines, plates, heat exchanger tubes, and the like.

US20190214224A1 describes a vibration control system. The vibration control system includes a plurality of actuator units each with a piezoelectric element that expands and contracts and extends from at least three different circumferential positions on the lateral face of a vibration-controlled object in at least three different directions to a base unit. This extension establishes connections between the lateral face of the vibration-controlled object and the base unit. A vibration detector detects the status of vibration of the vibration-controlled object including the amount and direction of vibration. A vibration controller controls the vibration of the vibration-controlled object by controlling the voltages supplied by a power source to the piezoelectric elements of the actuator units based on the status of vibration detected by the vibration detector, respectively, so that each of the actuator units contracts when the vibration-controlled object moves in a direction away from actuator unit and expands when the vibration-controlled object moves in a direction toward the actuator unit.

Each of the aforementioned references suffers from one or more drawbacks hindering their adoption, such as lacking specificity in detecting vibrational modes, and the like. Specifically, none of the aforementioned references describes using H-shaped calipers having piezoelectric wire(s) as the transducers for non-destructive testing through vibrational analysis, for purposes of assessing structural integrity and stiffness of cylindrical structures such as columns, pipes, poles, or tree trunks. These limitations restrict their effectiveness in accurately assessing the structural integrity of cylindrical elements, particularly in detecting early signs of decay or structural weaknesses, thereby emphasizing the requirement for a more reliable solution.

U.S. Pat. No. 11,175,263B1 describes an evaluation of an ovalling mode in a cylindrical object and determining the quality of the cylindrical object by analysis of the ovalling mode. The surface vibrations, as a result of a single applied force, of the cylindrical element are measured through a plurality of surface transducers, which are arranged on the cylindrical element along a circumference of the cylindrical element, by a processing circuitry. The surface transducers are equally spaced along the circumference of the cylindrical element. The digital signals corresponding to each of the surface transducers are processed to generate a composite digital signal by the processing circuitry. The composite digital signal is transformed to a frequency domain by the processing circuitry. The transformed composite digital signal is compared to a reference composite digital signal by the processing circuitry and the structural quality of the cylindrical element is determined based on the comparison. The processing comprises submitting the digitized signal to an operation where, first, the signals from two opposite positions (signals in phase) are summed resulting in two signal pairs, and second, the two signal pairs are subtracted from each other (signals in anti-phase).

While these systems have been effective in many respects, the evolving requirements of infrastructure safety, combined with advances in sensor technology and signal processing, highlight the need for enhanced sensitivity and precision. These systems employ configurations that, while functional, may not fully exploit the potential for more precise localization and characterization of structural anomalies. The detection of specific vibrational modes, such as the ‘ovalling’ mode in cylindrical structures, requires not only the identification of these modes but also analyzing and interpreting the data with high accuracy. By improving the way sensors are mounted and how signals are processed, it is possible to enhance the detection capabilities, thus providing a more reliable analysis of the structural integrity.

Accordingly, it is one object of the present disclosure to provide an improved system and method for non-destructively assessing the structural integrity and stiffness of cylindrical elements to accurately detect early signs of decay, which is applicable to elements in situ, and does not pose safety risks during evaluation. The present disclosure represents a step forward in addressing the needs for improved non-destructive testing technologies.

### SUMMARY

In an exemplary embodiment, a dual piezoelectric wire sensor system for non-destructive testing of a cylindrical structure is described. The dual piezoelectric wire sensor system includes a first H-shaped caliper configured to attach to the cylindrical structure at a first radial position, and a second H-shaped caliper configured to attach to the cylindrical structure at a second radial position located ninety degrees from the first radial position. Each H-shaped caliper includes a first arm, a second arm, and a crossbar connected to and perpendicular to the first arm and the second arm. A first caliper connector is located near a first end of the first arm, and a second caliper connector is located near a first end of the second arm. A first wire connector is located near a second end of the first arm, and a second wire connector is located near a second end of the second arm. A piezoelectric wire is connected to the first wire connector and the second wire connector, where the piezoelectric wire is stretched between the first wire connector and the second wire connector. An electrical terminal is connected to the piezoelectric wire at the second wire connector of each H-shaped caliper. The electrical terminal is configured to receive an electrical signal generated by the piezoelectric wire in response to expansions and contractions of a distance between the second end of the first arm and the second end of the second arm as a result of vibrations induced in the cylindrical structure. A two-port signal subtractor having a first port is connected to the electrical terminal of the first H-shaped caliper and a second port is connected to the electrical terminal of the second H-shaped caliper. The two-port signal subtractor is configured to subtract the electrical signals of the first H-shaped caliper from the electrical signals of the second H-shaped caliper and generate a difference signal. A measurement unit is connected to the two-port signal subtractor, the measurement unit is configured to receive the difference signal, amplify the difference signal, perform a frequency analysis of the difference signal, identify a resonant frequency of an ovalling mode of the difference signal and identify a stiffness value of the cylindrical structure based on the resonant frequency of the ovalling mode.

In another exemplary embodiment, a method for non-destructive testing of soundness of a cylindrical structure with a dual piezoelectric wire sensor system is described. The method includes attaching a first H-shaped caliper to the cylindrical structure at a first radial position and attaching a second H-shaped caliper to the cylindrical structure at a second radial position located ninety degrees from the first radial position. Each H-shaped caliper includes a first arm, a second arm, and a crossbar connected to and perpendicular to the first arm and the second arm. A first caliper connector is located near a first end of the first arm, and a second caliper connector is located near a first end of the second arm. A first wire connector is located near a second end of the first arm, and a second wire connector is located near a second end of the second arm. A piezoelectric wire is connected to the first wire connector and the second wire connector. The piezoelectric wire is stretched between the first wire connector and the second wire connector, and an electrical terminal is connected to the piezoelectric wire at the second wire connector of each H-shaped caliper. The method further includes inducing vibrations within the cylindrical structure by applying an impulse force to the cylindrical structure in a radial direction at one of a position located at in a range of about 10 cm to about 16 cm above the first and second radial positions and a position located at in a range of about 10 cm to about 16 cm below the first and second radial positions. The method further includes receiving, by the electrical terminal, an electrical signal generated by the piezoelectric wire in response to expansion and contraction of a distance between the second end of the first arm and the second end of the second arm as a result of the vibrations. The method further includes receiving, by a two-port signal subtractor having a first port connected to the electrical terminal of the first H-shaped caliper and a second port connected to the electrical terminal of the second H-shaped caliper, the electrical signals at the first port and the second port. The method further includes subtracting, by the two-port signal subtractor, the electrical signals. The method further includes generating, by the two-port signal subtractor, a difference signal. The method further includes receiving, by a measurement unit connected to the two-port signal subtractor, the difference signal. The method further includes performing, by the measurement unit, a frequency analysis of the difference signal. The method further includes identifying by the measurement unit, a resonant frequency of an ovalling mode of the difference signal. The method further includes identifying by the measurement unit, a stiffness value of the cylindrical structure based on the resonant frequency of the ovalling mode.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic top planar view illustration of a pair of H-shaped calipers being implemented for sensing an ovalling mode in a cylindrical structure, according to certain embodiments.

FIG. 1B is a schematic side planar view illustration of the pair of H-shaped calipers being implemented for sensing the ovalling mode in the cylindrical structure, according to certain embodiments.

FIG. 2 is an exemplary depiction of dynamic behavior of a cylindrical structure when subjected to an external excitation force, according to certain embodiments.

FIG. 3A is a schematic top planar view illustration of a dual piezoelectric wire sensor system, including the pair of H-shaped calipers, being implemented for non-destructive testing of a cylindrical structure, according to certain embodiments.

FIG. 3B is a schematic side planar view illustration of the dual piezoelectric wire sensor system being implemented for the non-destructive testing of the cylindrical structure, according to certain embodiments.

FIG. 4 is an exemplary block diagram of a measurement unit of the dual piezoelectric wire sensor system, according to certain embodiments.

FIG. 5 is an exemplary flowchart of a method for non-destructive testing of a cylindrical structure with the dual piezoelectric wire sensor system, according to certain embodiments.

FIG. 6 is an exemplary illustration of a numerical simulation of a finite length hollow cylinder vibrating in free-free boundary conditions for 2-dimensional case, according to certain embodiments.

FIG. 7 is an exemplary illustration of a numerical simulation of a finite length hollow cylinder vibrating in free-free boundary conditions for 3-dimensional case, according to certain embodiments.

FIG. 8 is an exemplary illustration of a numerical simulation of a finite length solid isotropic cylinder vibrating in clamped-free boundary conditions when excited at a middle thereof, according to certain embodiments.

FIG. 9 is an illustration of a non-limiting example of details of computing hardware used in the computing system, according to certain embodiments.

FIG. 10 is an exemplary schematic diagram of a data processing system used within the computing system, according to certain embodiments.

FIG. 11 is an exemplary schematic diagram of a processor used with the computing system, according to certain embodiments.

FIG. 12 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed towards a dual piezoelectric wire sensor system for non-destructive testing of a cylindrical structure and a method for non-destructive testing of the soundness of a cylindrical structure with the dual piezoelectric wire sensor system. The present disclosure addresses the limitations of traditional testing methods to provide evaluation of strength conditions of cylindrical structures, offering enhanced accuracy, safety, and efficiency in structural integrity assessments. The present disclosure incorporates two H-shaped calipers and two piezoelectric sensors to provide an approach to clamping and signal detection and assess the health and longevity of infrastructure components.

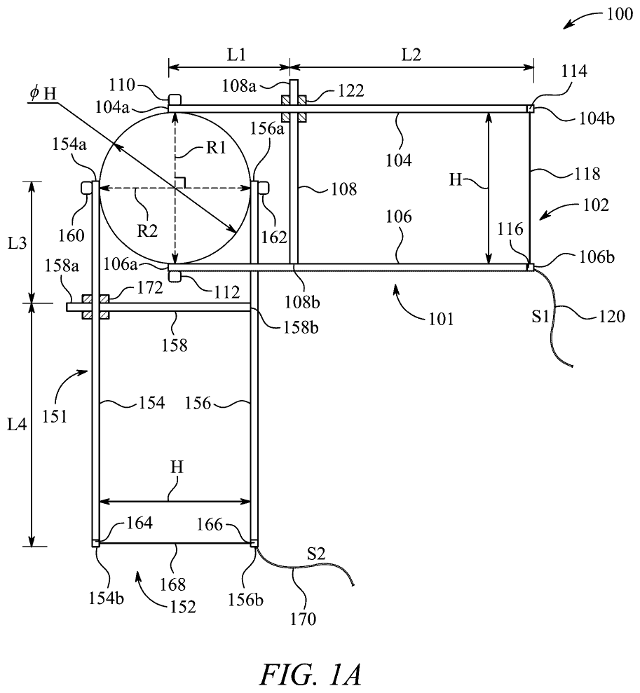

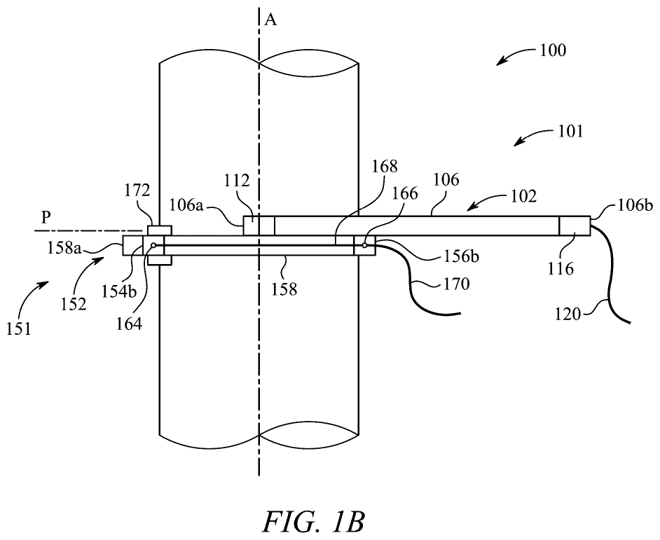

FIG. 1A illustrates a dual piezoelectric sensor arrangement 100 for sensing an ovalling mode in a cylindrical structure. The dual piezoelectric sensor arrangement 100 of the present disclosure implements a combination of two identical piezoelectric sensors, a first piezoelectric sensor 101 and a second piezoelectric sensor 151. The first piezoelectric sensor 101 and the second piezoelectric sensor 151 are attached to the circumference of the cylindrical structure at locations separated by ninety degrees radially from each other, for sensing the ovalling mode therein. The first piezoelectric sensor 101 and the second piezoelectric sensor 151 together address the requirement for an accurate assessment of the structural integrity of cylindrical structures. The first piezoelectric sensor 101 and the second piezoelectric sensor 151 operate on the principle of piezoelectricity, where mechanical stress, such as vibrations stimulated within the cylindrical structure, such as the vibration that induce an ovalling mode, are converted into electrical signals that may be measured and analyzed. The utility of the present disclosure extends across various industries where cylindrical structures are foundational elements. In construction, utility, and even the wood industry, the dual piezoelectric wire sensor system may be used to predict the lifespans of pillars, poles, and logs, thereby informing maintenance schedules, safety checks, and harvesting decisions.

As used herein, the “cylindrical structure” refers to any elongated object with a circular or approximately circular cross-section. The cylindrical structure includes a broad range of elements commonly used in various fields such as construction, utilities, and natural resources. Examples include metal or concrete columns that are utilized in building infrastructure, such as those found in bridges and harbor piers, as well as wooden poles used for supporting cables in electrical and telecommunication networks. Additionally, in the wood industry, the term extends to include tree trunks from which logs are derived for lumber production. In the present examples, the cylindrical structure may either be solid or hollow, and may be made of various materials such as metal, concrete, or wood without limitation. The dual piezoelectric sensor arrangement 100 of the present disclosure provides a non-destructive method for the assessment of the structural integrity of cylindrical structures.

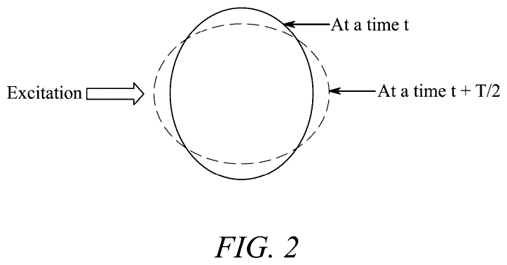

Further, the “ovalling mode” in the context of the cylindrical structure refers to the distortion of round cross-section of the cylindrical structure into an oval shape. This mode is a specific type of deformation that can occur under certain conditions, such as when the structure is subjected to external excitation forces or pressures that cause it to flex or bend. Referring to FIG. 2, a dynamic behavior of an exemplary cylindrical structure when subjected to an external excitation force is depicted. The force induces a distortion in the round cross-section of the cylinder, causing it to oscillate between a round and an oval shape, as seen at times t and t+T/2, respectively. This periodic distortion, known as the ovalling mode, is characterized by the alternating compressive and tensile stresses that occur around the circumference of the cylindrical structure. The ovalling mode is particularly significant in the assessment of structural integrity because it can indicate areas of weakness or potential failure within the cylindrical structure. By analyzing the presence and characteristics of the ovalling mode, it is possible to gain insights into the material properties and overall health of the cylindrical structure.

As the ovalling mode is an extensional mode of vibration in the case of cylindrical elements, its action is restricted to the plane cross-section of the cylindrical structure in the immediate vicinity of the point of application of the excitation force. Therefore, this mode of vibration is affected to a low degree, or not at all by the extent of the cylindrical structure in the axial direction. A precise electrical voltage response proportional to the amplitude of vibrational motion of the surface of the cylindrical structure may be acquired through a combination of two identical piezoelectric sensors mounted perpendicularly to each other on the cylindrical structure. The orthogonal arrangement of the piezoelectric sensors may ensure that the produced response signals, due to the ovalling mode of vibration, are out of phase with each other. Subtraction of these out-of-phase signals significantly enhances the resultant signal, facilitating more detailed analysis.

As illustrated in FIGS. 1A and 1B in combination, the first piezoelectric sensor 101 includes a first H-shaped caliper 102 and the second piezoelectric sensor 151 includes a second H-shaped caliper 152. Herein, the two piezoelectric sensors 101 and 151 preferably being identical, the two H-shaped calipers 102, 152 preferably have same dimensions and are preferably made of same material. The first H-shaped caliper 102 is attached to the surface of the cylindrical structure at a first radial position ‘R1’, and the second H-shaped caliper 152 is attached to the surface of the cylindrical structure at a second radial position ‘R2’ located substantially ninety degrees from the first radial position ‘R1’. Further, the first H-shaped caliper 102 and the second H-shaped caliper 152 are attached to the cylindrical structure on a same attachment plane ‘P’ normal to an axis ‘A’ of the cylindrical structure (as shown in FIG. 1B). The first H-shaped caliper 102 includes two arms, a first arm 104 and a second arm 106. In an example, the first arm 104 and the second arm 106 of the first H-shaped caliper 102 are of equal length. Similarly, the second H-shaped caliper 152 includes two arms, a first arm 154 and a second arm 156. In an example, the first arm 154 and the second arm 156 of the second H-shaped caliper 152 are of substantially equal length. The first H-shaped caliper 102 further includes a crossbar 108 connected to and perpendicular to the first arm 104 and the second arm 106. Similarly, the second H-shaped caliper 152 further includes a crossbar 158 connected to and perpendicular to the first arm 154 and the second arm 156.

Each of the H-shaped calipers 102 and 152 are designed to provide a stable base for the piezoelectric sensors 101 and 151, ensuring that they maintain contact with the cylindrical structure, to accurately detect the vibrational modes indicative of the structural health of the cylindrical structure. The first arm 104 and the second arm 106 of the first H-shaped caliper 102 are the primary contact elements that secure the first piezoelectric sensor 101 to the cylindrical structure, and the first arm 154 and the second arm 156 of the second H-shaped caliper 152 are the primary contact elements that secure the second piezoelectric sensor 151 to the cylindrical structure. The crossbar 108 of the first H-shaped caliper 102 provides structural support to the first arm 104 and the second arm 106 of the first H-shaped caliper 102 while the crossbar 158 of the second H-shaped caliper 152 provides structural support to the first arm 154 and the second arm 156 of the second H-shaped caliper 152. The crossbars 108, 158 further serve as references for aligning the piezoelectric sensors 101 and 151 perpendicular to the axis ‘A’ of the cylindrical structure.

The first arm 104 and the second arm 106 of the first H-shaped caliper 102 extend from the crossbar 108, which acts as a stabilizing backbone for the first H-shaped caliper 102, while the first arm 154 and second arm 156 of the second H-shaped caliper 152 extend from the crossbar 158, which acts as a stabilizing backbone for the second H-shaped caliper 152. In particular, the first arm 104 and the second arm 106 of the first H-shaped caliper 102 are positioned diametrically opposite to each other, and the first arm 154 and the second arm 156 of the second H-shaped caliper 152 are positioned diametrically opposite to each other when the H-shaped calipers 102, 152 are attached to the cylindrical structure.

Further, as mentioned above, the radial location of the first H-shaped caliper 102 on the cylindrical structure at the first radial position ‘R1’, and the radial location of the second H-shaped caliper 152 on the cylindrical structure at the second radial position ‘R2’ located substantially ninety degrees from the first radial position ‘R1’ arrange the two piezoelectric sensors 101, 151 such that they are disposed at ninety degrees to each other. This arrangement of attaching the two H-shaped calipers 102, 152 provides for a symmetrical application of the dual piezoelectric sensor arrangement 100, for detection of low vibration signals and accurate interpretation of the ovalling mode.

Also, as illustrated in FIG. 1A, in the first H-shaped caliper 102, the first arm 104 has a first end 104a and a second end 104b, and the second arm 106 has a first end 106a and a second end 106b. The first H-shaped caliper 102 includes a first caliper connector 110 located near the first end 104a of the first arm 104, and a second caliper connector 112 located near the first end 106a of the second arm 106. Similarly, in the second H-shaped caliper 152, the first arm 154 has a first end 154a and a second end 154b, and the second arm 156 has a first end 156a and a second end 156b. The second H-shaped caliper 152 includes a first caliper connector 160 located near the first end 154a of the first arm 154, and a second caliper connector 162 located near the first end 156a of the second arm 156. The caliper connectors 110, 112, 160, and 162 form the primary attachment points to the cylindrical structure that configures the dual piezoelectric sensor arrangement 100 to detect vibrations with precision and reliability. The caliper connectors 110, 112, 160, and 162 are the contact points that translate the structural vibrations of the cylindrical structure into measurable piezoelectric signals. The caliper connectors 110, 112, 160, and 162 are configured to firmly grip the exterior or circumference of the cylindrical structure without causing damage thereto. In general, the caliper connectors 110, 112, 160, and 162 are designed to facilitate easy attachment and detachment, providing convenience and efficiency for operators conducting multiple assessments across different cylindrical structures. In an aspect, the caliper connectors 110, 112, 160, and 162 may include a rubber surface that grips the cylindrical structure. In another aspect, the caliper connectors 110, 112, 160, and 162 may have a toothed surface that grips the cylindrical structure. In a further aspect, the caliper connectors 110, 112, 160, and 162 may have threaded ends which receive bolts that extend into the cylindrical structure to hold the corresponding ends 104a, 106a, 154a, and 156a of the H-shaped calipers 102, 152 securely against the cylindrical structure.

When the material of the cylindrical structure is relatively soft, such as wood, vinyl or other plastic, holes may be prepared in each of the first ends of the arms through which a screw is introduced and then driven into the material to attach the caliper's arms to the cylinder. For a steel cylinder, a magnet at the first ends of the arms may be used to attach the first ends to the cylindrical structure. For other materials, a steel patch may be glued on the cylindrical on either side of the diameter and a magnet is applied at the each first end of the arms to attaches the first ends to the cylinder.

In order to prevent the second end of each arm from falling, a steel wire may be attached to the center of the crossbar. The other end of the steel wire should be attached higher up on the cylinder (using any of the previous attaching means above according the cylinder material's character). A hook may also be attached to the cylinder for hosting through a ring the wire holding the transverse bar.

Alternatively, a stiff bar free to rotate may be mounted on the crossbar, with its other free end supported by a strut at a lower location on the cylinder.

Further, as illustrated in FIG. 1A, the first H-shaped caliper 102 includes a first wire connector 114 located near a second end 104b of the first arm 104, and a second wire connector 116 located near the second end 106b of the second arm 106. Also, the first H-shaped caliper 102 includes a piezoelectric wire 118 connected to the first wire connector 114 and the second wire connector 116. The wire connectors 114, 116, positioned near the second ends 104b, 106b of the first and second arms 104, 106, serve as anchorage points for the piezoelectric wire 118. The first wire connector 114, located near the second end 104b of the first arm 104, is configured to securely attach one end of the piezoelectric wire 118, and the second wire connector 116, located near the second end 106b of the second arm 106, is configured to secure the other end of the piezoelectric wire 118. Similarly, the second H-shaped caliper 152 includes a first wire connector 164 located near the second end 154b of the first arm 154, and a second wire connector 166 located near the second end 156b of the second arm 156. Also, the second H-shaped caliper 152 includes a piezoelectric wire 168 connected to the first wire connector 164 and the second wire connector 166. The wire connectors 164, 166, positioned near the second ends 154b, 156b of the arms 154, 156, serve as anchorage points for the piezoelectric wire 168. The first wire connector 164, located near the second end 154b of the first arm 154, is configured to securely attach one end of the piezoelectric wire 168, and the second wire connector 166, located near the second end 156b of the second arm 156, is configured to secure the other end of the piezoelectric wire 168.

The spatial arrangement between the wire connectors 114 and 116, and the spatial arrangement between the wire connectors 164 and 166 are defined to ensure that the respective piezoelectric wires 118 and 168 span the distance across the cylindrical structure being analyzed. This arrangement facilitates the effective transmission of vibrational energy from the cylindrical structure to the piezoelectric wires 118 and 168, configuring the dual piezoelectric sensor arrangement 100 to detect the changes in vibrational characteristics of the cylindrical structure that are indicative of the ovalling mode. The piezoelectric wires 118 and 168 are held between their respective wire connectors at a defined tension which is equal for each of the piezoelectric wires.

The piezoelectric wires 118 and 168 are made from a material that exhibits piezoelectric properties, which convert mechanical stress induced by the vibrations of the cylindrical structure into electrical signals. In a non-limiting example, the piezoelectric wires 118 and 168 may be piezo cables which are another form of piezo polymer sensors, designed as a coaxial cable with a piezo polymer interior structure. Herein, the piezo polymer is the “dielectric” between a center core and an outer braid. When a piezo cable is compressed or stretched, a charge or voltage proportional to the stress is generated proportional to the stress.

The piezoelectric wire 118 is stretched between the first wire connector 114 and the second wire connector 116, and the piezoelectric wire 168 is stretched between the first wire connector 164 and the second wire connector 166. Each of the piezoelectric wires 118 and 168 has a length equal to about a diameter ‘H’ of the cylindrical structure. The positioning of the wire connectors 114, 116 near the second ends 104b, 106b of the first and second arms 104, 106 of the first H-shaped caliper 102, and the positioning of the wire connectors 164, 166 near the second ends 154b, 156b of the arms 154, 156 of the second H-shaped caliper 152 provide for the necessary mechanical leverage to apply the appropriate tension to the corresponding piezoelectric wires 118 and 168. In an example, the first piezoelectric sensor 101 and the second piezoelectric sensor 151 of the dual piezoelectric sensor arrangement 100 are placed at a position located in a range of about 10 centimeters (cms) to about 16 cms above or below the position of the excitation signal, to avoid the possible interference of local deformations and of near fields caused by the excitation signal. The tension applied to the piezoelectric wire 118, as a result of being stretched between the two wire connectors 114 and 116 is calibrated to enhance the sensitivity of the first piezoelectric wires 118 to the vibrational modes of interest. Similarly, the tension applied to the piezoelectric wire 168, as a result of being stretched between the wire connectors 164 and 166 is also calibrated to enhance the sensitivity of the piezoelectric wire 168 to the vibrational modes of interest.

Further, as illustrated, the first H-shaped caliper 102 includes an electrical terminal 120, and the second H-shaped caliper 152 includes an electrical terminal 170. The electrical terminal 120 is connected to the corresponding piezoelectric wire 118 at the second wire connector 116, and the electrical terminal 170 is connected to the corresponding piezoelectric wire 168 at the second wire connector 166. In general, the electrical terminal 120 is connected to the piezoelectric wire 118 at the second end 106b of the second arm 106, and the electrical terminal 170 is connected to the piezoelectric wire 168 at the second end 156b of the second arm 156. As a result of the structural vibrations, a electrical signal ‘S1’ is generated by the piezoelectric wire 118, and an electrical signal ‘S2’ is generated by the piezoelectric wire 168. Herein, the electrical terminal 120 is configured to receive the electrical signal ‘S1’ generated by the piezoelectric wire 118 in response to the expansion and contraction of a distance between the second end 104b of the first arm 104 and the second end 106b of the second arm 106 as a result of vibrations induced in the cylindrical structure. Similarly, the electrical terminal 170 is configured to receive the electrical signal ‘S2’ generated by the piezoelectric wire 168 in response to the expansion and contraction of a distance between the second end 154b of the third 154 and the second end 156b of the second arm 156 as a result of vibrations induced in the cylindrical structure. The electrical terminal 120 is configured to serve as a conduit for the electrical signal ‘S1’ generated by the piezoelectric wire 118, and the electrical terminal 170 is configured to serve as a conduit for the electrical signal ‘S2’ generated by the piezoelectric wire 168. The two signals ‘S1’ and ‘S2’ are analog signals as these signals ‘S1’ and ‘S2’ are derived directly due to the contraction and expansion of the piezoelectric wires 118 and 168. The electrical terminals 120 and 170 are designed to minimize any resistance or impedance that could distort or attenuate the electrical signals, ensuring that the electrical signals generated by the piezoelectric wires 118 and 168 in response to the vibrations in the cylindrical structure are accurately transmitted for subsequent analysis.

As discussed, the electrical signal ‘S1’ received by the electrical terminal 120 is a direct result of the piezoelectric effect, which occurs due to the expansion and contraction of the distance between the second end 104b of the first arm 104 and the second end 106b of the second arm 106. Similarly, the electrical signal ‘S2’ received by the electrical terminal 170 is a direct result of the piezoelectric effect, which occurs due to the expansion and contraction of the distance between the second end 154b of the first arm 154 and the second end 156b of the second arm 156. These movements of expansion and contraction are induced by vibrations within the cylindrical structure, which are characteristic of the ovalling mode as detected by the first piezoelectric sensor 101 and the second piezoelectric sensor 151.

The electrical terminals 120 and 170 are configured to effectively receive signals resulting from a wide range of vibrational frequencies and amplitudes, enhancing the applicability of the dual piezoelectric sensor arrangement 100 across different types of cylindrical structures and materials. The sensitivity of the electrical terminals 120 and 170 provides for the detection of even subtle changes in the electrical signals, which may indicate early signs of structural compromise within the cylindrical structure.

This configuration ensures that the piezoelectric sensors 101 and 151, when applied to the cylindrical structure, can effectively sense changes in the dimensions of the cylindrical structure as it undergoes stress, for determining the presence and severity of potential structural issues. Overall, the relative radial locations ‘R1’ and ‘R2’ of the H-shaped calipers 102 and 152, with their specific dimensions and materials, are designed to enhance the sensitivity of the piezoelectric sensors 101 and 151 to vibrational frequencies of the ovalling mode. By ensuring that the piezoelectric sensors 101 and 151 are firmly attached and correctly positioned, the H-shaped calipers 102 and 152 facilitate the precise detection of minute distortions in the shape of the cylindrical structure. These distortions, captured as electrical signals by the piezoelectric sensors 101 and 151, form the basis of a detailed analysis of the structural integrity of the cylindrical structure.

In the present configuration of the first piezoelectric sensor 101, the first caliper connector 110 and the second caliper connector 112 are connected to the cylindrical structure at positions in which the first end 104a of the first arm 104 and the first end 106a of the second arm 106 are diametrically opposite across the cylindrical structure. Such arrangement of the first 104 and second arm 106 across the cylindrical structure ensures that the piezoelectric wire 118, which is stretched between the first wire connector 114 and the second wire connector 116, is aligned along the diameter ‘H’ of the cylindrical structure. Similarly, in the case of the second piezoelectric sensor 151, the first caliper connector 160 and the second caliper connector 162 are connected to the cylindrical structure at positions in which the first end 154a of the first arm 154 and the first end 156a of the second arm 156 are diametrically opposite across the cylindrical structure. Such arrangement of the first arm 154 and the second arm 156 across the cylindrical structure ensures that the piezoelectric wire 168, which is stretched between the first wire connector 164 and the second wire connector 166, is aligned along the diameter ‘H’ of the cylindrical structure. These alignments of the caliper connectors 110, 112 of the first H-shaped caliper 102, and the caliper connectors 160, 162 of the second H-shaped caliper 152 ensure that the piezoelectric sensors 101 and 151 maintain their intended orientation throughout the testing process, thereby enhancing the reliability and consistency of the data collected.

As mentioned above, the first radial position ‘R1’ of the first H-shaped caliper 102 of the first piezoelectric sensor 101 is located ninety degrees from the second radial position ‘R2’ of the second H-shaped caliper 152 of the second piezoelectric sensor 151. Further, the first H-shaped caliper 102 and the second H-shaped caliper 152 are attached to the cylindrical structure on the same attachment plane ‘P’ normal to the axis ‘A’ of the cylindrical structure. This arrangement of the H-shaped calipers 102, 152 of the piezoelectric sensors 101, 151 may facilitate the precise detection of electric signals for even the minute contraction and expansion of the cylindrical structure due to the ovalling mode of vibration.

These alignments of the caliper connectors 110, 112 of the first H-shaped caliper 102, and the caliper connectors 160, 162 of the second H-shaped caliper 152, along with the ninety degrees radial location of the second radial position ‘R2’ of the second H-shaped caliper 152 to the first radial position ‘R1’ of the first H-shaped caliper 102 provide for accurately capturing the radial expansion and contraction indicative of the ovalling mode, as it configures the piezoelectric wires 118 and 168 to directly and simultaneously sense the changes in diameter that occur during vibration. This arrangement further stabilizes the piezoelectric sensors 101 and 151 on the cylindrical structure, minimizing any potential movement or slippage that could distort the readings of the piezoelectric sensors 101 and 151.

The length and material of the first arm 104, the second arm 106, the first arm 154, and the second arm 156 are chosen to optimize the transmission of vibrational energy to the piezoelectric wires 118 and 168, in the piezoelectric sensors 101 and 151. Further, the first arm 104, the second arm 106, the first arm 154, and the second arm 156 are designed to be long enough to provide sufficient flexure and movement for the piezoelectric wires 118 and 168 to generate measurable electrical responses to the vibrations caused by the ovalling mode.

In an aspect of the present disclosure, a length ‘L2’ of each arm 104, 106 from the crossbar 108, of the first H-shaped caliper 102, to each second end 104b, 106b is larger than a length ‘L1’ from each caliper connector 110, 112 to the crossbar 108. Herein, the length ‘L2’ from the crossbar 108 to each second end 104b, 106b is configured to amplify the vibrations in the piezoelectric wire 118 by increasing the expansion and contraction of the distance between the first end 104a of the first arm 104 and the first end 106a of the second arm 106. Therefore, when the cylindrical structure vibrates, the second ends 104b, 106b of the arms 104, 106 move apart and together, resulting in an expansion and contraction of the distance across the diameter ‘H’ of the cylindrical structure. It may be appreciated that the longer the length ‘L2’ in the arms 104, 106, the greater the movement at the second ends 104b, 106b for a given amount of structural vibration. This amplification of movement is transferred to the piezoelectric wire 118, which in turn produces a more substantial electrical signal in response to the mechanical stress. In general, a shorter ‘L1’ ensures that the caliper connectors 110, 112 are close to the crossbar 108, which provides a stable base for the first piezoelectric sensor 101. Meanwhile, a longer ‘L2’ ensures that the piezoelectric wire 118 has enough range of motion to detect even minor vibrations, thus providing a precise measurement of the stiffness and integrity of the cylindrical structure. Similarly, a length ‘L4’ of each arm 154, 156 from the crossbar 158, of the second H-shaped caliper 151 to each second end 154b, 156b is larger than a length ‘L3’ from each caliper connector 160, 162 to the crossbar 158. Herein, the length ‘L4’ from the crossbar 158 to each second end 154b, 156b is configured to amplify the vibrations in the piezoelectric wire 168 by increasing the expansion and contraction of the distance between the first end 154a of the first arm 154 and the first end 156a of the second arm 156. Therefore, when the cylindrical structure vibrates, the second ends 154b, 156b of the arms 154, 156 move apart and together, resulting in an expansion and contraction of the distance across the diameter ‘H’ of the cylindrical structure. It may be appreciated that the longer the length ‘L4’ in the arms 154, 156, the greater the movement at the second ends 154b, 156b for a given amount of structural vibration. This amplification of movement is transferred to the piezoelectric wire 168, which in turn produces a more substantial electrical signal in response to the mechanical stress. In general, a shorter ‘L3’ ensures that the caliper connectors 160, 162 are close to the crossbar 158, which provides a stable base for the second piezoelectric sensor 151. Meanwhile, a longer ‘L4’ ensures that the piezoelectric wire 168 has enough range of motion to detect even minor vibrations, thus providing a precise measurement of stiffness and integrity of the cylindrical structure. The length ‘L4″ has an upper bound of no more than three times the length ‘L3’, as increasing the length past three times the length ‘L3″ increases the noise in the received signals, may reduce the tension in the piezoelectric wires and affect the stability of the system.

In a further aspect of the present disclosure, the length ‘L2’ of each arm 104, 106 from the crossbar 108 to each second end 104b, 106b is about two times the length ‘L1’ from each caliper connector 110, 112 to the crossbar 108. Such an approximate doubling of the length ‘L2’ compared to ‘L1’ maximizes the mechanical advantage when vibrations occur in the cylindrical structure. As a result, small movements at the point of the caliper connectors 110, 112 are translated into larger movements at the second ends 104b, 106b of the arms 104, 106. This mechanical leverage provides the piezoelectric wire 118 with sensitivity to measure the distance changes between the second ends 104b, 106b. Similarly, the length ‘L4’ of each arm 154, 156 from the crossbar 158 to each second end 154b, 156b is about two times the length ‘L3’ from each caliper connector 160, 162 to the crossbar 158. Such an approximate doubling of the length ‘L4’ compared to ‘L3’ maximizes the mechanical advantage when vibrations occur in the cylindrical structure. As a result, small movements at the point of the caliper connectors 160, 162 are translated into larger movements at the second ends 154b, 156b of the arms 154, 156. This mechanical leverage provides the piezoelectric wire 168 with sensitivity to measure the distance changes between the second ends 154b, 156b. The greater the movement, the larger the variation in tensions of the piezoelectric wires 118, 168 leading to more significant electrical signals when the piezoelectric wires 118, 168 respond to the induced structural vibrations.

In aspects of the present disclosure, a length ‘H’ of the crossbar 108 is equal to the diameter ‘H’ of the cylindrical structure. Similarly, a length ‘H’ of the crossbar 158 is equal to the diameter ‘H’ of the cylindrical structure. Such lengths ‘H’ of the crossbars 108, 158 provide for a direct and uniform application of the corresponding H-shaped calipers 102 and 152 across the circumference of the cylindrical structure, ensuring that the piezoelectric sensors 101 and 151 can be precisely positioned for optimal performance. Specifically, by matching the length ‘H’ of the crossbars 108 and 158 to the diameter ‘H’ (i.e., the cross-sectional diameter) of the cylindrical structure, the piezoelectric sensors 101 and 151 are aligned such that the induced vibrations from the ovalling mode are simultaneously captured in their most pronounced form. Moreover, this specific design consideration facilitates the quick and easy installation of the piezoelectric sensors 101 and 151, as the crossbars 108 and 158 serve as an immediate visual and physical guide to ensure that the piezoelectric sensors 101 and 151 are correctly applied to the cylindrical structure.

As shown, the crossbar 108 of the first H-shaped caliper 102 includes a first end 108a and a second end 108b, and the crossbar 158 of the second H-shaped caliper 152 includes a first end 158a and a second end 158b. In an aspect of the present disclosure, the first H-shaped caliper 102 includes an adjustable clamp 122 connected to the first arm 104 of the first H-shaped caliper 102 at a position in which the first end 108a of the crossbar 108 intersects the first arm 104. As may be seen, the second end 108b of the crossbar 108 is fixed to the second arm 106 of the first H-shaped caliper 102, and the first end 108a of the crossbar 108 is connected to the adjustable clamp 122. Herein, the adjustable clamp 122 is configured to attach the first end 108a of the crossbar 108 to the first arm 104 at a position on the crossbar 108 in which the length ‘H’ of the crossbar 108 is equal to the diameter ‘H’ of the cylindrical structure. For this purpose, the adjustable clamp 122 on the first end 108a of the crossbar 108 may be configured to adjustably attach the first end 108a of the crossbar 108 to the first arm 104 of the first H-shaped caliper 102 such that the spatial distance between the first arm 104 and the second arm 106 may be adjusted to be equal in length to the diameter ‘H’ of the cylindrical structure. Similarly, the second H-shaped caliper 152 includes an adjustable clamp 172 connected to the first arm 154 of the second H-shaped caliper 152 at a position in which the first end 158a of the crossbar 158 intersects the first arm 154. As may be seen, the second end 158b of the crossbar 158 is fixed to the second arm 156 of the second H-shaped caliper 152, and the first end 158a of the crossbar 158 is connected to the adjustable clamp 172. Herein, the adjustable clamp 172 is configured to attach the first end 158a of the crossbar 158 to the first arm 154 at a position on the crossbar 158 in which a length ‘H’ of the crossbar 158 is equal to the diameter ‘H’ of the cylindrical structure. For this purpose, the adjustable clamp 172 on the first end 158a of the crossbar 158 may be configured to adjustably attach the first end 158a of the crossbar 158 to the first arm 154 of the second H-shaped caliper 152 such that the spatial distance between the first arm 154 and the second arm 156 may be adjusted to be equal in length to the diameter ‘H’ of the cylindrical structure.

In an aspect of the present disclosure, the first arm 104, the second arm 106, and the crossbar 108 of the first H-shaped caliper 102, and the first arm 154, the second arm 156, and the crossbar 158 of the second H-shaped caliper 152 are formed of metal. The utilization of metal provides the necessary rigidity and durability required for the H-shaped calipers 102 and 152, and in general, the piezoelectric sensors 101 and 151, to withstand the physical stresses of operation and the environmental conditions to which they may be exposed. The choice of metal also provides for a consistent transmission of vibrational energy from the cylindrical structure to the piezoelectric wires 118 and 168, for the accurate conversion of the mechanical vibrations into the electrical signals. Moreover, the inherent properties of the metal ensure a long service life for the piezoelectric sensors 101 and 151, thereby reducing the requirement for frequent replacements, which in turn enhances the overall efficiency and cost-effectiveness of the use of the dual piezoelectric sensor arrangement 100. The metal may be selected from the group comprising titanium, stainless steel, carbon steel and iron. The metal must be strong but light-weight in order to retain the H-bar calipers in the perpendicular orientation to the axis of the cylindrical structure. Titanium is used for cylinder less than 15 cm. in diameter. For cylinder greater than or equal to 15 cm. in diameter, a stronger material, such as carbon steel, should be used.

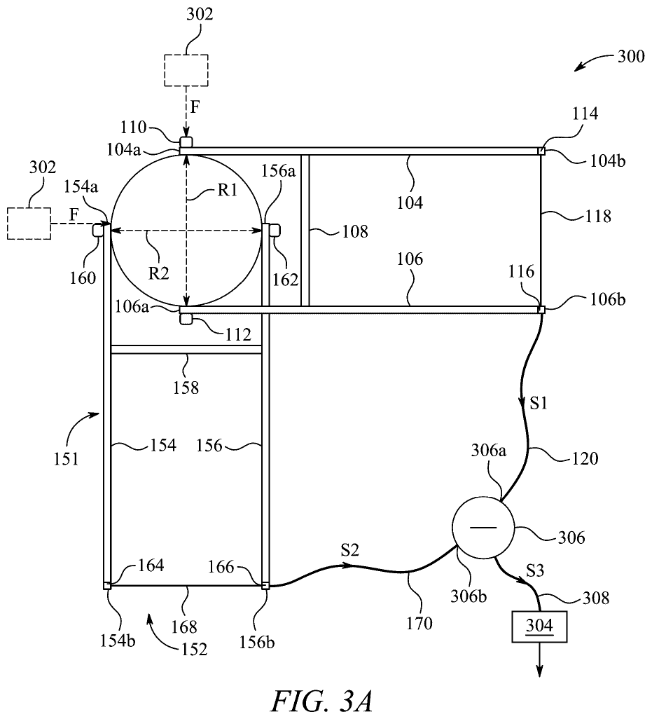

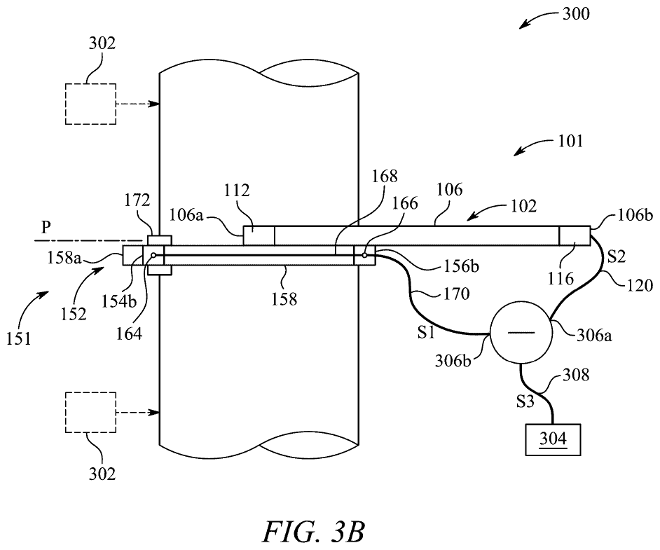

Referring now to FIGS. 3A and 3B in combination, illustrated is a schematic diagram of a dual piezoelectric wire sensor system 300 for non-destructive testing of a cylindrical structure. The dual piezoelectric wire sensor system 300 of the present disclosure implements the dual piezoelectric sensor arrangement 100, which includes the first H-shaped caliper 102 attached to the cylindrical structure at the first radial position ‘R1’ and the second H-shaped caliper 152 attached to the cylindrical structure at the second radial position ‘R2’ located ninety degrees from the first radial position ‘R1’, as discussed in the preceding paragraphs. The dual piezoelectric wire sensor system 300 has the electrical terminal 120 connected to the piezoelectric wire 118 near the second end 106b of the second arm 106 of the first piezoelectric sensor 101, and the electrical terminal 170 connected to the piezoelectric wire 168 near the second end 156b of the second arm 156 of the second piezoelectric sensor 151. The dual piezoelectric wire sensor system 300 is configured to provide precise, reliable data that can inform maintenance decisions, safety evaluations, and long-term planning for infrastructure management. The dual piezoelectric wire sensor system 300 is designed as a portable apparatus such that assessments can be carried out regularly and efficiently, with minimal disruption to the service or function of the structure under evaluation.

In a non-limiting example, for a cylindrical structure of diameter one meter, the crossbar is adjusted to one meter, the first arm and the second arm have lengths of three meters and the length of the piezoelectric wire between the ends of the first arm and the second arm is one meter.

As illustrated, the dual piezoelectric wire sensor system 300 includes a transducer 302 configured to induce vibrations in the cylindrical structure. The transducer 302 is configured to provide mechanical energy, to generate vibrational waves that propagate through the cylindrical structure. As shown, the transducer 302 is configured to apply a controlled excitation force ‘F’ to the cylindrical structure, thereby inducing the specific vibrational mode, namely the ovalling mode, that the dual piezoelectric sensor arrangement 100 is designed to detect. In present examples, the transducer 302 may be any one of a hammer, an electrodynamic shaker, a thumper, a pendulum strung from above, and the like. The placement of the transducer 302 is calculated to ensure that the induced vibrations are evenly distributed across the cylindrical structure, providing a comprehensive excitation in the dual piezoelectric sensor arrangement 100. Specifically, the transducer 302 is placed at a location so that it impacts the cylindrical structure at a position located in a range of about 10 cm to about 16 cm above or below the first and second radial positions ‘R1’, ‘R2’. In other words, the transducer 302 is placed at a position located at in a range of about 10 cm to about 16 cm above or below the attachment plane ‘P’ (as better illustrated in FIG. 3B). The transducer 302 is typically configured to operate over a range of frequencies to accommodate various structural dimensions and material properties. The flexibility in frequency selection ensures that the dual piezoelectric wire sensor system 300 can be applied to different types of cylindrical structures, from small-diameter pipes to large-scale columns, and made of diverse materials such as metal, concrete, or wood.

In an aspect of the present disclosure, the transducer 302 is a hammer and the vibrations are initiated by the impulse force ‘F’ generated by the hammer at a location ninety degrees from the first caliper connector 110 and opposite the position of the piezoelectric wire 118, or at another location ninety degrees from the first caliper connector 160 and opposite the position of the piezoelectric wire 168 on the cylindrical structure (as depicted in FIG. 3A). That is, the transducer 302 employed within the dual piezoelectric wire sensor system 300 takes the form of the hammer, which is utilized to impart the impulse force ‘F’ in a radial direction along the direction of one of the piezoelectric sensors and perpendicular to the other piezoelectric sensor, on the cylindrical structure. The force ‘F’ is applied at a location that is ninety degrees from the first caliper connector 110, or at another location that is ninety degrees from the first caliper connector 160. One of these specific locations is chosen because it is opposite the position where the piezoelectric wire 118 or the piezoelectric wire 168 is mounted on the cylindrical structure, for inducing the desired ovalling mode effectively. The impulse force ‘F’ generated by the hammer strike is sudden and of short duration, which is ideal for creating a broad range of frequencies necessary to excite various vibrational modes within the cylindrical structure.

In another aspect of the present disclosure, the transducer 302 is an electrodynamic shaker and the vibrations are initiated by the impulse force ‘F’ generated by the electrodynamic shaker. The electrodynamic shaker produces a controlled impulse force ‘F’ to initiate vibrations within the cylindrical structure. Similar to the hammer, the electrodynamic shaker is positioned at a location ninety degrees from the first caliper connector 110 and opposite a position of the piezoelectric wire 118, or at another location ninety degrees from the first caliper connector 160 and opposite a position of the piezoelectric wire 168 on the cylindrical structure. The electrodynamic shaker can generate a continuous range of vibrational frequencies by varying the electrical input signal, providing a comprehensive assessment of response from the cylindrical structure across the frequency spectrum. It may be appreciated that the use of the electrodynamic shaker as the transducer 302 provides for a more refined control over the frequency and amplitude of the force ‘F’ applied, which may be required for cylindrical structures that require specific vibrational inputs for determining their integrity state accurately. The transducer 302 is a single transducer shown in FIG. 3A and FIG. 3B as being applied at either of the two locations shown.

As discussed, the electrical terminal 120 is configured to receive the electrical signal ‘S1’ generated by vibrations in the piezoelectric wire 118 in response to the expansion and contraction of a distance between the second end 104b of the first arm 104 and the second end 106b of the second arm 106 as the result of the vibrations induced in the cylindrical structure. Similarly, the electrical terminal 170 is configured to receive the electrical signal ‘S2’ generated by vibrations in the piezoelectric wire 168 in response to the expansion and contraction of a distance between the second end 154b of the first arm 154 and the second end 156b of the second arm 156 as the result of the vibrations induced in the cylindrical structure. These movements are the physical manifestations of the vibrational modes induced by the transducer 302, specifically the ovalling mode, which is a key indicator of the structural health of the cylindrical structure. The piezoelectric wires 118 and 168 react to the mechanical stress of the vibrations and produce electrical signals due to the inherent properties of the piezoelectric material used therein. The electrical terminal 120 is configured to interface with the piezoelectric wire 118, and the electrical terminal 170 is configured to interface with the piezoelectric wire 168, ensuring the transmission of the electrical signals containing information regarding the structural integrity of the cylindrical structure.

The dual piezoelectric wire sensor system 300 further includes a two-port signal subtractor 306 having a first port 306a connected to the electrical terminal 120 of the first H-shaped caliper 102 and a second port 306b connected to the electrical terminal 170 of the second H-shaped caliper 152. The two-port signal subtractor 306 is configured to subtract the electrical signals ‘S1’ of the first H-shaped caliper 102 from the electrical signals ‘S2’ of the second H-shaped caliper 152 and generate a difference signal ‘S3’. The similarity in the dimensions of the first H-shaped caliper 102 and the second H-shaped along with the perpendicular arrangements between them, in which the piezoelectric wire 118 perpendicular to the piezoelectric wire 168 when the dual piezoelectric sensor arrangement 100 is mounted on the cylindrical structure with the caliper connectors 110, 112, 160, and 162 as described above. The ninety-degree arrangement of the piezoelectric wires 118, 168 ensures that the produced electrical signals ‘S1’ and ‘S2’ are completely out of phase with each other. Hence, subtracting the electrical signals ‘S1’ and ‘S2’ from one another enhances output as the difference signal ‘S3’, which is desired before being converted into a digital signal.

In particular, when the diameter ‘H’ of the cylindrical structure along the first radial position ‘R1’ contracts, the diameter ‘H’ of the cylindrical structure along the second radial position ‘R2’ expands (as may be understood from FIG. 2), which, in turn, contracts the piezoelectric wire 118 and expands the piezoelectric wire 168, resulting in the vibrations sensed by the piezoelectric wire 168 completely out of phase (also referred to as, anti-phase or 180 degrees) from the vibrations sensed by the piezoelectric wire 118. Subtracting the two electrical signals ‘S1’ and ‘S2’ from one another takes the opposite phase of the electrical signal ‘S2’ and adds it to the electrical signal ‘S1’ which results in a doubling of the amplitude of the desired ovalling mode and at the same time reducing the exhibition of odd-numbered expansional modes. Thus, the difference signal ‘S3’ generated by the two-port signal subtractor 306 is an amplified signal of the ovalling mode of vibration. In other words, the two-port signal subtractor 306 acts as a signal amplifier for the output signal of the dual piezoelectric sensor arrangement 100, which is especially helpful for detecting vibrations of low amplitudes.

Furthermore, the dual piezoelectric wire sensor system 300 includes a measurement unit 304 connected to the two-port signal subtractor 306. As shown, the measurement unit 304 is connected to the two-port signal subtractor 306 by a third electrical terminal 308. The measurement unit 304 is connected to the two-port signal subtractor 306 to provide an interface for the electrical signals ‘S1’, ‘S2’ captured by the dual piezoelectric sensor arrangement 100. In general, the measurement unit 304 is configured to receive the difference signal ‘S3’ from the two-port signal subtractor 306. The measurement unit 304 is further configured to perform a frequency analysis of the difference signal ‘S3’. The measurement unit 304 is further configured to identify a resonant frequency of the ovalling mode of the difference signal ‘S3’. The measurement unit 304 is further configured to identify a stiffness value of the cylindrical structure based on the resonant frequency of the ovalling mode.

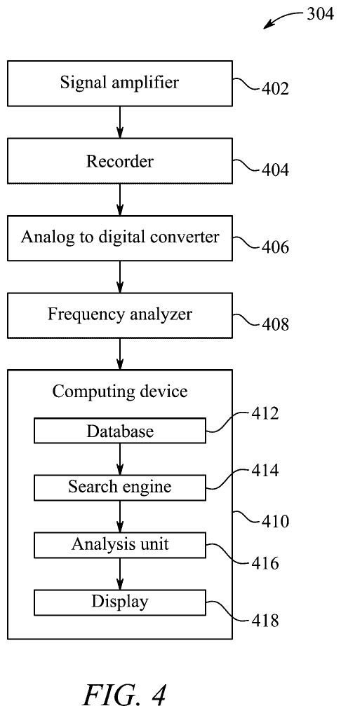

Referring to FIG. 4, illustrated is a detailed block diagram of the measurement unit 304. As shown, in an aspect of the present disclosure, the measurement unit 304 includes a signal amplifier 402. The signal amplifier 402 receives the difference signal ‘S3’ from the third electrical terminal 308. The signal amplifier 402 is configured to amplify the difference signal ‘S3’ and generate an amplified difference signal. It may be contemplated that the difference signal ‘S3’ generated by the two-port signal subtractor 306, which includes the vibrational characteristics of the cylindrical structure under test, may still be of low amplitude, especially when the structural vibrations are subtle. The signal amplifier 402 ensures that these electrical signals are amplified to a level where they can be effectively processed and analyzed in the measurement unit 304. The signal amplifier 402 may be configured to amplify the electrical signal without distorting its frequency content, which is important for identifying the specific vibrational modes present in the cylindrical structure, including the ovalling mode. In the present examples, the signal amplifier 402 may utilize filters and other signal conditioning features to ensure that only the relevant frequencies associated with the structural vibrations are amplified, while unwanted noise or interference is minimized.

The measurement unit 304 also includes a recorder 404 configured to record the amplified difference signal for off-site processing and to generate a time stamp of a sampling time of the electrical signal ‘S3’. That is, the recorder 404 is configured to store the difference signal ‘S3’ received from the amplifier 402 (or, in some cases, directly from the two-port signal subtractor 306 through the third electrical terminal 308, such as, when the amplifier 402 is not employed). The recorder 404 also provides for off-site processing, which provides the flexibility to conduct analysis using more specialized equipment or software that may not be available or practical to use in the field. Additionally, the recorder 404, with the ability to time stamp and store the electrical signal data, can be utilized to provide a comprehensive historical analysis of the structural condition of the cylindrical structure, which, in turn, can be utilized for identifying trends in the behavior of the cylindrical structure, predicting potential failure points, and planning maintenance activities.

The measurement unit 304 further includes an analog to digital converter 406. The analog to digital converter 406 is connected to the recorder 404 (or, in some cases, directly to the signal amplifier 402), to receive the amplified difference signal. The analog to digital converter 406 is configured to transform the amplified difference signal to a digital signal. The transformation performed by the analog to digital converter 406 involves sampling the continuous analog signal at discrete intervals and quantizing the amplitude of the electrical signal into digital values that can be processed by a digital computing systems. This conversion provides the advanced signal processing techniques required to extract meaningful information from the vibrational data, such as frequency analysis and the identification of resonant frequencies indicative of the structural condition, as discussed in the following paragraphs.

The measurement unit 304 further includes a frequency analyzer 408 configured to perform the frequency analysis of the digital signal by using a fast discrete Fourier transform to generate a frequency spectrum of the digital signal. Herein, upon receiving the digital signal, the frequency analyzer 408 is configured to decompose the digital signal into its constituent frequencies (converting the time-domain signal into a frequency spectrum), a process that often utilizes a Fast Fourier Transform (FFT) or similar algorithm. This is done to identify the dominant frequencies within the signals that correspond to the vibrational modes of the cylindrical structure, particularly the ovalling mode that indicates the structural stiffness. In an aspect of the present disclosure, the frequency spectrum is configured to range from 20 hertz (Hz) to 2000 Hz. That is, the frequency spectrum generated by the FFT of the digital signal is specifically configured to cover a range from 20 to 2000 Hz. This range is selected to cover the typical frequencies at which the resonant modes of cylindrical structures, including the ovalling mode, are expected to occur. It may be understood that the choice of this frequency range is based on empirical data and theoretical models that suggest that most resonant frequencies of interest for common cylindrical structures, such as construction columns, pillars, and logs, fall within this spectrum.

In an aspect of the present disclosure, the computing device 410 is configured to identify the resonant frequency of the ovalling mode based on a second harmonic of the difference signal ‘S3’. For this purpose, the program instructions are executed to perform a frequency analysis of the frequency spectrum to determine the resonant frequency of the ovalling mode. Following the generation of the frequency spectrum, the computing device 410 is configured for frequency analysis specifically aimed at identifying the resonant frequency associated with the ovalling mode. The ovalling mode, characterized by the expansion and contraction of the cylindrical structure, is an indicator of structural health and stiffness. Identifying the resonant frequency of the ovalling mode provides the inherent physical properties of the cylindrical structure and can indicate the presence of potential structural weaknesses or damages. The second harmonic, being twice the frequency of the fundamental vibrational mode, provides a more distinct signature of the ovalling mode, to help differentiate from other vibrational modes that may be present in the cylindrical structure. This further helps in mitigating the potential for interference from external noise, thereby improving the reliability and accuracy of the testing process. Therefore, by focusing on the second harmonic signals, the frequency analysis can more accurately isolate the resonant frequency of the ovalling mode, thereby enhancing the precision of the structural assessment.

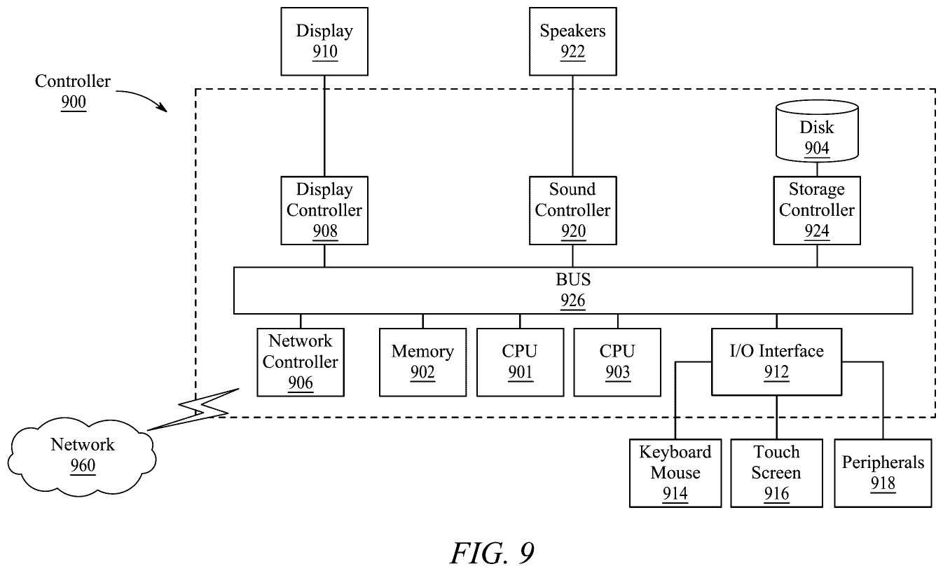

The measurement unit 304 further proceeds with a series of analytical steps to assess the structural integrity of the cylindrical structure. The measurement unit 304 includes a computing device 410 having electrical circuitry, a memory storing program instructions, and at least one processor configured to execute the program instructions to perform the said analytical steps. The details of the computing device 410 are discussed later in the description in reference to FIGS. 9-12. Herein, the computing device 410 receives the digital signal, as generated by subtraction of the electrical signal ‘S1’ and the electrical signal ‘S2’ from each other by the two-port signal subtractor 306, amplified and converted to digital form. The digital signal includes the vibrational data of the cylindrical structure under investigation.

The program instructions are executed to perform a frequency response analysis to identify the resonant frequencies and amplitudes of the resonant frequencies of the digital signal and identify the ovalling mode of the resonant frequencies and amplitudes of the digital signal. Herein, the computing device 410 initiates the frequency response analysis by utilizing the frequency spectrum (as generated by the frequency analyzer 408), as it facilitates the identification of resonant frequencies within the digital signal. These resonant frequencies represent the vibrational modes of the cylindrical structure being tested. Further, for each identified frequency, its amplitude is also determined, which is used for evaluating the energy or intensity of the vibration at that frequency. Each amplitude is a direct reflection of the vibrational energy at that point, representative of the response of the cylindrical structure to external or internal forces. Identifying the resonant frequencies and their amplitudes provides a baseline for detecting any deviations from normal vibrational behavior expected for a structurally sound cylindrical structure. The computing device 410 stores these frequencies and amplitudes, creating a profile of the vibrational states of the cylindrical structure.

The computing device 410, then, proceeds to identify the specific ovalling mode among the resonant frequencies. As may be understood, the ovalling mode is characterized by its distinct frequency and amplitude. To accurately identify the ovalling mode, the computing device 410 analyzes the amplitude patterns alongside the resonant frequencies. The amplitude of the resonant frequency of the ovalling mode provides a quantitative measure of the vibrational energy associated with the ovalling mode, which is directly correlated to the structural stiffness and integrity of the cylindrical structure. If the amplitude is significantly different from expected levels, it may indicate a decrease in stiffness and an increased risk of structural failure.

The computing device 410 also includes a database 412 stored in the memory. The database 412 contains database records of ovalling modes that are associated with various stiffness values of cylindrical structures. These database records are categorized based on specific characteristics such as the diameter and material of the cylindrical structure. That is, the database 412 contains records of frequencies corresponding to known ovalling modes, each corresponding to stiffness values for cylindrical structures that share the same cross-sectional size and material composition as the cylindrical structure under test. It may be understood that the database records within the database 412 are derived from empirical data and theoretical models, including a wide range of cylindrical structures made from various materials. The inclusion of the database 412 helps in translating the vibrational data into meaningful insights regarding the structural integrity of the cylindrical structure under examination. This classification provides for a detailed approach to comparing observed data with established benchmarks, facilitating accurate assessments of structural integrity.

The computing device 410 further includes a search engine 414 to interact with the database 412 to retrieve and match data efficiently. Specifically, the search engine 414 is configured to search the database 412 to match the ovalling mode of the digital signal to an ovalling mode recorded in the database 412. That is, when the computing device 410 identifies an ovalling mode from the digital signal, the search engine 414 queries the database 412 to find a corresponding ovalling mode recorded within it. This comparison helps to determine whether the observed ovalling mode falls within normal ranges for a cylindrical structure of similar diameter and material or if it indicates potential structural issues.

The computing device 410 further includes an analysis unit 416. The analysis unit 416 within the computing device 410 is configured to determine a soundness score of the cylindrical structure based on the stiffness value. Herein, the soundness score is derived from the stiffness value associated with the identified ovalling mode, which the search engine 414 matches against the database records. The analysis unit 416 considers the amplitude and frequency of the ovalling mode, comparing these with historical data to evaluate the current condition of the cylindrical structure. The stiffness value reflects the rigidity of the material and its ability to resist deformation under stress. The stiffness value is influenced by the frequency and amplitude of the ovalling mode, where higher frequencies and lower amplitudes may indicate a stiffer and potentially healthier structure, whereas lower frequencies and higher amplitudes may indicate deterioration or damage. Once the stiffness value is established, the analysis unit 416 utilizes a set of algorithms to convert this quantitative measure into the soundness score. The soundness score is typically normalized against a scale, for example, from 0 to 100, where higher scores may indicate better health of the cylindrical structural.

The computing device 410 may also include a display 418, in signal communication with the analysis unit 416. The display 418 serves as the interface for visualizing data and analysis results. Once the soundness score is determined, the analysis unit 416 outputs this score onto the display 418, providing a quantifiable measure of overall health and stability of the cylindrical structure. The display 418 may be configured to show the soundness score in various formats, such as numerical readings, graphical representations, or alongside other relevant structural health indicators, depending on the requirements of the users. The displayed soundness score provides an easily interpretable measure of the condition of the cylindrical structure, facilitating immediate and informed decision-making regarding maintenance, monitoring, and potential reinforcement or repair activities.

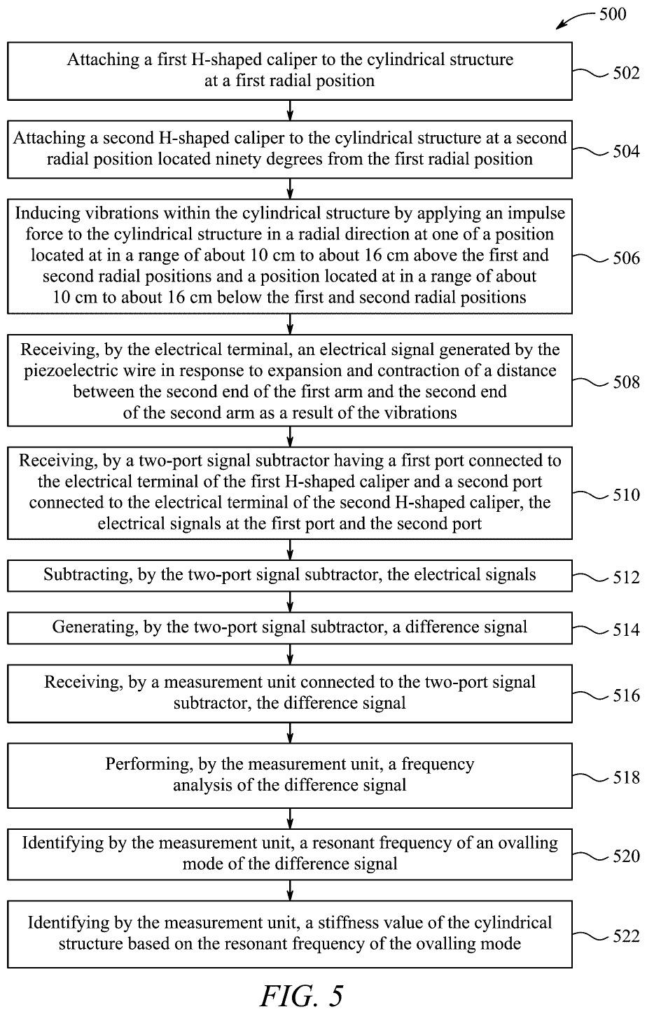

The present disclosure further provides a method for non-destructive testing of soundness of a cylindrical structure. Referring to FIG. 5, illustrated is a flowchart listing steps involved a method 500 for the non-destructive testing of soundness of the cylindrical structure. These steps are only illustrative, and other alternatives can also be provided where one or more steps are added, one or more steps are removed, or one or more steps are provided in a different sequence without departing from the scope of the claims herein. Various aspects and variants disclosed above, for the aforementioned dual piezoelectric wire sensor system 300 apply mutatis mutandis to the method 500, as discussed in the proceeding paragraphs.

At step 502, the method 500 includes attaching the first H-shaped caliper 102 to the cylindrical structure at the first radial position ‘R1’. Further, at step 504, the method 500 includes attaching the second H-shaped caliper 152 to the cylindrical structure at the second radial position ‘R2’ located ninety degrees from the first radial position ‘R1’. These steps 502, 504 involve connecting the first end 104a of the first arm 104 and the first end 106a of the second arm 106 of the first H-shaped caliper 102 across the diameter ‘H’ of the cylindrical structure at the first radial position ‘R1’ at the first height from the bottom on the attachment plane ‘P’, normal to the axis of the solid cylindrical structure, and connecting the first end 154a of the first arm 154 and the first end 156a of the second arm 156 of the second H-shaped caliper 152 across the diameter ‘H’ of the cylindrical structure at the second radial position ‘R2’ located ninety degrees from the first radial position on the same attachment plane ‘P’ of the solid cylindrical structure. This establishes the positioning of the dual piezoelectric sensor arrangement 100, ensuring its precise alignment with the cylindrical structure for optimal detection of vibrational modes. The first ends 104a and 106a of the arms 104 and 106, respectively of the first H-shaped caliper 102, are securely affixed to the surface of the cylindrical structure, spanning its diameter. Similarly, the first ends 154a and 156a of the arms 154 and 156, respectively of the second H-shaped caliper 152, are securely affixed to the surface of the cylindrical structure, spanning its diameter. The piezoelectric wire 118 between the second ends 104b, 106b of the arms 104, 106 and the piezoelectric wire 168 between the second ends 154b, 156b of the arms 154, 156 are stretched to directly intercept the radial expansions and contractions characteristic of the ovalling mode in the cylindrical structure and are connected to the electrical terminal 120 and the electrical terminal 170, respectively. Further, the electrical terminal 120 of the piezoelectric wire 118 is connected to the first port 306a of the two-port signal subtractor 306 and the electrical terminal 170 of the piezoelectric wire 168 is connected to the second port 306b of the two-port signal subtractor 306.

At step 506, the method 500 includes inducing vibrations within the cylindrical structure by applying an impulse force to the cylindrical structure in a radial direction at one of a position located at in a range of about 10 cm to about 16 cm above the first and second radial positions ‘R1’ and ‘R2’ and a position located at in a range of about 10 cm to about 16 cm below the first and second radial positions ‘R1’ and ‘R2’. Such a procedure initiates the vibrational modes within the cylindrical structure, particularly targeting the ovalling mode for the assessment of the stiffness of the cylindrical structure. The selection of the second height, in a range of about 10 cm to about 16 cm above or below the position of the H-shaped calipers 102 and 152, ensures that the induced vibrations propagate effectively through the cylindrical structure, engaging the piezoelectric wires 118 and 168. This height differential enhances the vibrational response of the cylindrical structure, ensuring that the dual piezoelectric wire sensor system 300 can effectively detect the resonant frequencies indicative of the stiffness of the cylindrical structure. In an example, the method 500 involves inducing vibrations in the cylindrical structure by applying a stress pulse radially. This impulse is designed to encompass the frequencies of the lowest natural vibrational modes of the cylindrical structure, particularly focusing on those modes that exhibit vibration amplitudes along the circumference of the cylindrical structure. Among these modes, the ovalling mode, characterized by a bending wavelength about half the circumference of the cylinder, is given special consideration.

At step 508, the method 500 includes receiving, by the electrical terminal 120, 170, the electrical signal ‘S1’ and ‘S2’ generated by the piezoelectric wire 118, 168 in response to expansion and contraction of the distance between the second end 104b of the first arm 104 and the second end 106b of the second arm 106 as a result of the vibrations. The said connections provide for the transmission of the electrical signal ‘S1’ generated by the piezoelectric wire 118 in response to structural vibrations to the electrical terminal 120, as well as the transmission of the electrical signal ‘S2’ generated by the piezoelectric wire 168 in response to structural vibrations to the electrical terminal 170.

At step 510, the method 500 includes receiving, by the two-port signal subtractor 306 having the first port 306a connected to the electrical terminal 120 of the first H-shaped caliper 102 and the second port 306b connected to the electrical terminal 170 of the second H-shaped caliper 152, the electrical signals ‘S1’, ‘S2’ at the first port 306a and the second port 306b. The electrical terminal 120 serves as the interface between the first H-shaped caliper 102 and the two-port signal subtractor 306, while the electrical terminal 170 serves as the interface between the second H-shaped caliper 152 and the two-port signal subtractor 306. The electrical signals ‘S1’ and ‘S2’ are completely out of phase with each other, as the piezoelectric wires 118, 168 are perpendicular to each other, and the attachment of the caliper connectors 110, 112 of the first H-shaped caliper 102 are diametrically opposite to the cylindrical structure, as well as the caliper connectors 160, 162 of the second H-shaped caliper 152 are diametrically opposite to the cylindrical structure.

At step 512, the method 500 includes subtracting, by the two-port signal subtractor 306, the electrical signals ‘S1’ and ‘S2’. Subtracting the electrical signals ‘S1’ and ‘S2’ from one another enhances the output signal. In particular, subtracting the two electrical signals ‘S1’ and ‘S2’ from one another takes the opposite phase of the electrical signal ‘S2’ and add it to the electrical signal ‘S1’ which may result in a doubling of the amplitude of the sought ovalling mode and at the same time reducing the exhibition of odd-numbered expansion modes. At step 514, the method 500 includes generating, by the two-port signal subtractor 306, the difference signal ‘S3’. The difference signal ‘S3’ is generated by subtracting the electrical signal ‘S1’, generated as a result of the expansion and contraction of the piezoelectric wire 118, in response to expansion and contraction of a distance between the second end 104b of the first arm 104 and the second end 106b of the second arm 106 due to the vibrations induced in the cylindrical structure, and the second electrical ‘S2’, generated as a result of the expansion and contraction of the piezoelectric wire 168, in response to expansion and contraction of a distance between the second end 154b of the first arm 154 and the second end 156b of the second arm 156 due to the vibrations induced in the cylindrical structure. Therefore, the difference signal ‘S3’ output by the two-port signal subtractor 306, generated by subtracting the two electrical signals ‘S1’ and ‘S2’ from one another, is an amplified signal of the ovalling mode of vibration.

At step 516, the method 500 includes receiving, by the measurement unit 304 connected to the two-port signal subtractor 306, the difference signal ‘S3’. The measurement unit 304 receives the difference signal ‘S3’ from the two-port signal subtractor 306. The difference signal ‘S3’ captures the vibrational data for assessing the structural integrity of the cylindrical structure. Herein, the difference signal ‘S3’ corresponds to the dynamic response of the cylindrical structure to the induced vibrations, and thus includes information on the vibrational modes, including the ovalling mode.

At step 518, the method 500 includes performing, by the measurement unit 304, the frequency analysis of the difference signal ‘S3’. This frequency analysis is employed for isolating the specific vibrational mode associated with the structural stiffness of the cylindrical structure. The measurement unit 304 initiates its analysis by conducting a frequency analysis of the difference signal ‘S3’. The frequency analysis is performed using techniques such as the Fast Fourier Transform (FFT), which transforms the time-domain signal into a frequency-domain representation. This transformation facilitates the measurement unit 304 to determine all present frequencies and their corresponding amplitudes.

At step 520, the method 500 includes identifying by the measurement unit 304, the resonant frequency of the ovalling mode of the difference signal ‘S3’. After obtaining the frequency spectrum, the measurement unit 304 proceeds to identify the specific resonant frequency that characterizes the ovalling mode. Such resonant frequency of the ovalling mode is directly related to the structural integrity of the cylindrical structure. The resonant frequency is typically distinct and can be recognized due to its predefined characteristics based on empirical data and theoretical understanding of material and construction of the cylindrical structure under test.

At step 522, the method 500 includes identifying by the measurement unit 304, the stiffness value of the cylindrical structure based on the resonant frequency of the ovalling mode. Once the resonant frequency of the ovalling mode is identified, the measurement unit 304 uses this frequency to determine the stiffness value of the cylindrical structure. The stiffness value is a parameter that quantifies the rigidity of the structure and its ability to resist deformation under stress. The relationship between the stiffness and the resonant frequency is derived from the principle that stiffer materials tend to vibrate at higher frequencies. By analyzing the resonant frequency, the measurement unit 304 can determine the stiffness of the cylindrical structure, based on the material properties and the diameter ‘H’ of the cylindrical structure.

In an aspect of the present disclosure, the method 500 further includes amplifying, by the signal amplifier 402 of the measurement unit 304, the difference signal ‘S3’ and generating the amplified difference signal. The signal amplifier 402 within the measurement unit 304 receives the difference signal ‘S3’, which contains the filtered vibrational characteristics of the cylindrical structure, emphasizing the ovalling mode. The signal amplifier 402 amplifies the difference signal ‘S3’ to ensure that the subsequent data processing steps have the amplified difference signal, which facilitates more accurate analysis. The method 500 further includes recording, on the recorder 404, the amplified difference signal. The recorder 404 records the amplified difference signal for maintaining a record of the signal at this stage, which may be used for off-site processing or historical analysis. The method 500 further includes transforming, by the analog to digital converter 406 of the measurement unit 304, the amplified difference signal to the digital signal. The analog to digital converter 406 transforms the amplified difference signal into the digital signal for executing digital signal processing techniques such as Fast Fourier Transform (FFT), and thereby facilitates more precise analysis of frequency content of the signal ‘S3’. The method 500 further includes performing, by the frequency analyzer 408 of the measurement unit 304, the frequency analysis of the digital signal by the fast discrete Fourier transform to generate the frequency spectrum of the digital signal. The generated frequency spectrum of the digital signal provides all present frequencies and their corresponding amplitudes, to facilitate further analysis.

The method 500 further includes performing, by the computing device 410 having electrical circuitry, the memory storing program instructions, and at least one processor configured to execute the program instructions, the frequency response analysis identifying the resonant frequencies and amplitudes of the resonant frequencies of the digital signal and identifying the ovalling mode of the resonant frequencies and amplitudes of the digital signal. This analysis identifies the resonant frequencies and their amplitudes and isolates the ovalling mode within the spectrum of the digital signal. The method 500 further includes performing, by the computing device 410, the search of the database 412 storing database records of ovalling modes related to the stiffness value of cylindrical structures based on the diameter ‘H’ and the material of the cylindrical structure and matching the ovalling mode of the digital signal to the ovalling mode recorded in the database 412. This matching process involves comparing the identified resonant frequency with the reference records in the database 412 that correlates to known ovalling mode frequencies with corresponding stiffness values for various cylindrical structures. This comparison configures the measurement unit 304 to determine the stiffness value of the cylindrical structure under test, based on the resonant frequency of its ovalling mode. In an example, from charts established for the resonant frequencies of the ovalling mode in sound cylindrical elements of the same geometrical shape and made of the same material as the investigated cylindrical structure, a comparison can be made between the value of the measured frequency and the ones on the chart according to the cross-sectional size of the cylindrical structure. In another example, from charts established for the resonant frequencies of the ovalling mode in sound cylindrical elements comparison can be made between the value of the measured frequency and the ones on the chart according to the cross-sectional size of the cylindrical structure and the material of its composition.

The method 500 further includes determining, by the computing device 410, the soundness score of the cylindrical structure based on the stiffness value. Based on the stiffness value derived from the identified ovalling mode and the matched data from the database 412, the computing device 410 calculates the soundness score for the cylindrical structure. The soundness score provides a quantifiable measure of health of the cylindrical structure, reflecting its current condition and potential longevity. The method 500 further includes outputting, by the computing device 410, the soundness score onto the display 418 of the computing device 410. That is, finally, the soundness score is output onto the display 418 of the computing device 410. The displayed soundness score provides valuable feedback to the users, such as, but not limited to, inspectors and maintenance personnel, and configure them to make informed decisions regarding safety, maintenance requirements, or suitability for continued use for the cylindrical structure.

In another aspect of the present disclosure, the method 500 further includes amplifying, by the signal amplifier 402 of the measurement unit 304, the difference signal ‘S3’ and generating the amplified difference signal. The signal amplifier 402 receives the difference signal ‘S3’, which reflects vibrational characteristics potentially indicating structural anomalies or conditions. This difference signal ‘S3’ is amplified to enhance the clarity of its constituent frequencies. The method 500 further includes recording, on the recorder 404, the amplified difference signal. That is, the recorder 404 captures and stores the amplified difference signal. Storing the signal at this stage facilitates potential re-analysis or historical comparison, such as for monitoring structural changes over time or verifying the effects of applied interventions. The method 500 further includes transforming, by the analog to digital converter 406 of the measurement unit 304, the amplified difference signal to the digital signal. This digital transformation facilitates detailed digital signal processing, including frequency analysis through advanced computational techniques. The method 500 further includes performing, by the frequency analyzer 408 of the measurement unit 304, the frequency analysis of the digital signal by the fast discrete Fourier transform to generate the frequency spectrum of the digital signal. This frequency spectrum systematically lists all detectable frequencies and their corresponding amplitudes, derived from the digital signal.

The method 500 further includes performing, by the computing device 410 having electrical circuitry, the memory storing program instructions, and at least one processor configured to execute the program instructions, the frequency response analysis identifying the resonant frequencies and amplitudes of the resonant frequencies of the digital signal and identifying the ovalling mode of the resonant frequencies and amplitudes of the digital signal. That is, the computing device 410 then processes this frequency spectrum to identify resonant frequencies and their amplitudes and specifically to identify the ovalling mode, indicative of integrity of the cylindrical structure. The method 500 further includes generating, by the computing device 410, the mathematical model of the cylindrical structure. That is, concurrently, the computing device 410 generates the mathematical model of the cylindrical structure. This model simulates expected vibrational behaviors based on known physical properties such as diameter, material stiffness, and structural geometry. The method 500 further includes modelling, by the computing device 410, the resonant frequencies and amplitudes of the ovalling mode as the function of diameter ‘H’ and the corresponding stiffness value of the cylindrical structure. That is, the resonant frequencies and amplitudes associated with the ovalling mode are then modeled as functions of diameter ‘H’ of the cylindrical structure and the corresponding stiffness value. This creates a framework that links physical dimensions and material properties with specific vibrational signatures. The method 500 further includes matching, by the computing device 410, the resonant frequency and amplitude of the ovalling mode of the digital signal to the ovalling mode of the mathematical model for the corresponding diameter ‘H’ of the cylindrical structure. This provides for validating the observed data against theoretical expectations.

The method 500 further includes determining the stiffness value of the cylindrical structure based on the matched resonant frequency and amplitude of the ovalling mode of the digital signal. From the matched data, the stiffness value of the cylindrical structure is determined. The stiffness value is a direct measure of ability of the cylindrical structure to resist deformation under load, indicative of its overall structural health. The method 500 further includes determining, by the computing device 410, the soundness score of the cylindrical structure based on the stiffness value. Using the derived stiffness value, the computing device 410 calculates the soundness score for the cylindrical structure, which quantifies the health status of the structure, integrating various analysis results into a single metric. The method 500 further includes outputting, by the computing device 410, the soundness score onto the display 418 of the computing device 410. This visualization provides immediate and clear feedback on the structural condition, aiding in decision-making for maintenance, repair, or further detailed inspection.

In an example, determining the soundness score of the cylindrical structure from the stiffness value involves analyzing the inferred stiffness value in relation to established thresholds for structural health. Herein, the stiffness value, derived from the resonant frequency of the ovalling mode, is interpreted in the context of the material properties, geometric dimensions, and expected performance criteria of the cylindrical structure. The measurement unit 304 utilizes the stiffness value as the indicator of the structural integrity, assessing whether the cylindrical structure remains within safe operational limits or exhibits signs of degradation that could compromise its functionality and safety. The method 500 further includes generating, by the measurement unit 304, a structural integrity report. The structural integrity report may include data, including the stiffness value, the comparison against reference values from the database 412, and the resultant determination of the structural integrity. The structural integrity report may also include recommendations for further actions, such as maintenance, monitoring, or repair, based on the assessed condition of the cylindrical structure. The method 500 further includes outputting the structural integrity report of the cylindrical structure on the display 418. This provides immediate accessibility to the assessment results, configuring for on-site review and decision-making.

In some examples, the method 500 further includes determining, from the frequency analysis, an amplitude of the resonant frequency of the ovalling mode. This involves an examination of the frequency spectrum generated by the FFT of the digital signal to understand the vibrational characteristics of the cylindrical structure, as the amplitude of the resonant frequency provides insights into the ovalling mode within the vibrational behavior of the cylindrical structure. The method 500 further includes generating, by the measurement unit 304, a computer model of the cylindrical structure based on the frequency analysis. This computer model incorporates the identified resonant frequencies, including that of the ovalling mode, and their corresponding amplitudes, providing a comprehensive simulation of the vibrational behavior of the cylindrical structure. The method 500 further includes comparing the computer model to a reference database record of ovalling mode frequencies and ovalling mode amplitudes of the cylindrical structure for example, as a function of cross-sectional size like perimeter or average diameter. Such comparison validates the accuracy of the computer model and for interpreting its findings in the context of known structural behaviors. By matching resonant frequencies and amplitudes of the computer model against the database records, the degree to which the structure conforms to expected norms is evaluated. The resultant computer model serves as a virtual prototype, providing detailed analysis and visualization of response of the cylindrical structure to vibrational stimuli, for diagnosing structural issues and planning remedial actions.

In some examples, the method 500 further includes generating, by the measurement unit 304, a graph which represents the resonant frequencies of ovalling modes as a function of cross-sectional diameters of cylindrical structures. This graph serves as a diagnostic tool, providing the identification of trends and patterns in how the resonant frequencies vary with changes in cross-sectional diameters of the cylindrical structures. The method 500 further includes comparing, by the measurement unit 304, the resonant frequency of the ovalling mode of the computer model to the graph. This involves aligning the specific resonant frequency obtained from the digital simulation of the vibrational behavior of the cylindrical structure with the broader trends depicted in the graph. Such comparison provides for the contextualization of the vibrational response of the cylindrical structure within the spectrum of expected behaviors for structures of similar dimensions and materials. The method 500 further includes determining, by the measurement unit 304, a degree of strength weakening factors of the cylindrical structure. This determination is based on the analysis of the resonant frequencies and their comparison to established references, providing for the quantification of the impact of factors such as material processing such as casting, filling, tempering, cooling, and the like, environmental influences, or physical damages (corrosion, flaws, rot, and the like) on overall strength and stability of the cylindrical structure. The method 500 further includes generating, by the measurement unit 304, a report of the structural integrity of the cylindrical structure based on the degree of strength weakening factors. This report outlines the vibrational characteristics of the cylindrical structure, the degree to which strength-weakening factors may be affecting its integrity, and recommendations for further action. The method 500 further includes displaying, on the display 418 of the measurement unit 304, the report of the structural integrity. Such display of the structural integrity report provides for immediate interpretation of the results and facilitates informed decision-making regarding the management and maintenance of the cylindrical structure under examination.

For purposes of the present disclosure, the cylindrical structure is one of a solid cylindrical structure and a hollow cylindrical structure. That is, the present method 500 can be applied to broad spectrum of cylindrical structures, including solid cylindrical structures as well as hollow cylindrical structures, such as a construction column, a wooden pole, a log, a tree trunk, a bridge pile or a pipe for transporting oil or gas. The method 500 may also be of extended application to similarly shaped elements as may be used for bearing telephone or electricity cables, and in standing trees, and which may be affected by the attack of rot or parasites. The solid cylindrical structures, such as concrete pillars or metal rods, are characterized by their uniform material composition throughout their cross-section, which influences their vibrational modes and resonant frequencies in specific ways. On the other hand, hollow cylindrical structures, like pipes or tubes, have an empty space or cavity along their central axis, which significantly affects their dynamic behavior in different ways. By accommodating both solid and hollow configurations, the method 500 is configured to provide reliable assessments of structural integrity, regardless of the specific type of cylindrical structure being evaluated.

To summarize, in an exemplary scenario, to perform the test, an operator makes note of the material composition and diameter of the test cylindrical structure. The operator then inputs to the computer in the measurement unit 304, by means of a simple keyboard operation, the test cylindrical structure characteristics such as material composition and diameter. The caliper connectors 110, 112 on arms 104, 106 of the first H-shaped caliper 102 are firmly attached on diametrically opposite sides of the test cylindrical structure. Then, the caliper connectors 160, 162 on arms 154, 156 of the second H-shaped caliper 152 are also firmly attached on diametrically opposite sides of the test cylindrical structure. The first H-shaped caliper 102 and the second H-shaped caliper 152 are fixed perpendicularly to one another on a plane perpendicular to the axis of the test cylindrical structure. The operator then sets the test cylindrical structure under investigation into vibration by means of the transducer 302 (such as, the hammer 302) of appropriate size and suitable tip hardness in order to excite the ovalling mode of vibration. The position of impact of the hammer 302 is at a range of about 10 cm to about 16 cm above or below the H-shaper calipers 102, 152 radially and perpendicular to the diameter where the caliper connectors 110, 112 of the first H-shaped caliper 102 are attached or and perpendicular to the diameter where the caliper connectors 160, 162 of the second H-shaped caliper 152 are attached. The two electrical signals ‘S1’, ‘S2’ from the piezoelectric wires 118, 168 are subtracted from each other, and the generated difference signal ‘S3’ is transported to the recorder 404 if later analysis is wished at another place. Should on-site measurements be made, then the recorder 404 can be bypassed and analog difference signal ‘S3’ is amplified and converted to the digital signal on which an FTT is applied on a laptop hosting software and analysis system. The amplitude of the resulting frequency response, as then processed by the software in the laptop computer, is then studied and the resonant frequency of the ovalling mode is read and compared to the corresponding value on a standard curve drawing the frequency of the ovalling mode as a function of cross-sectional size of the test specimen. The relative decrease of the resonant frequency of the ovalling mode, then, provides the stiffness value of the cylindrical test specimen hence classifying it as sound, acceptable, weak or to be discarded.

The use of the transducer 302 is for generating electrical signals, in the form of voltages, translating the vibratory surface motion of the cylindrical structure under test. The transient signal recorded by the transducer 302 is conveyed to the recorder 404 or the computing device 410 or the frequency analyzer 416. The difference signal ‘S3’ may also be analyzed off-site, as it may be recorded for further processing and analysis later. At a suitable later time and location, the recorded signal of the test specimen may be played back into the analog to digital converter 406, which digitizes and converts the signal into a form that is usable by computer hardware and software for this purpose. The signal is afterward fed into the computing device 410 (computer) equipped with analysis software operating on digitized data which executes the FFT on the difference signal ‘S3’. The FFT operation results in a frequency response, or a transfer function (TF), a translation of the signal into the frequency domain. The resonant frequencies are then read on the graph of the amplitude of the TF and the frequency of the ovalling mode is identified. The computer also has a routine to determine the stiffness condition of the test specimen depending on the material making the test cylindrical structure and its cross-sectional dimension given either as its perimeter or its average diameter at the positions of the transducer 302.

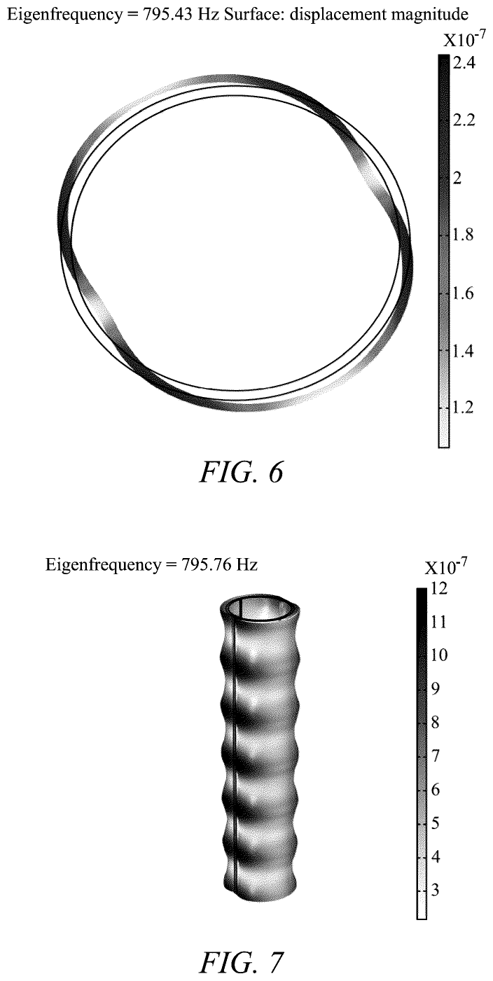

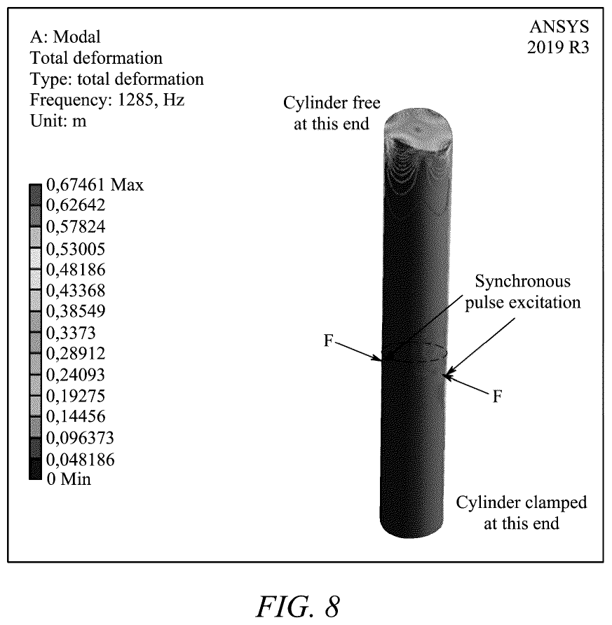

Referring now to FIG. 6 and FIG. 7, depicted are results of a numerical simulation using a COMSOL-MATLAB code for the n=2 circumferential mode in a finite length hollow cylinder vibrating in free-free boundary conditions. In particular, the depiction of FIG. 6 corresponds to 2-dimensional case, for cross-section displacement, with frequency of vibration (FoV) being 795 Hz, and the depiction of FIG. 7 corresponds to 3-dimensional case, for overall cylinder behavior, with FoV being 796 Hz. A numerical simulation was performed to model the n=2 circumferential vibration mode of a hollow cylindrical structure, specifically a PVC pipe with precise diameter and wall thickness measurements. The simulation provided a visual representation of vibrational behavior of the cylindrical structure, both in a cross-sectional view and as a complete entity. The computational analysis was executed using finite element method (FEM) software, integrating COMSOL with MATLAB, to accurately depict the vibrational response of the PVC material structure. In the cross-sectional depiction of FIG. 6, the vibration mode resembles an “8-figure” shape, noticeably more oval and constricted at opposing ends than a simple elliptical pattern. This distinct shape is indicative of the ovalling mode, which is characterized by its double-lobed deformation pattern, contrasting with the initial elliptical assumption. Additionally, the full-body representation of the cylindrical structure in FIG. 7 reveals a periodic vibration pattern along its axis. This pattern may be attributed to the Poisson effect in the compression-expansion of the material during vibration.

Referring to FIG. 8, depicted is a result of a numerical simulation of the ovalling mode in a clamped-free solid isotropic cylinder subject to a pair of synchronous identical radial force pulses applied to its midst. The characteristics of the cylindrical structure are defined by a height of 3.00 meters, a diameter of 0.45 meters, a material density (p) of 490 kilograms per cubic meter, and a modulus of elasticity (MoE) of 750 megaPascals (MPa), providing a comprehensive representation of the vibrational response in a clamped-free boundary condition scenario. This represents a finite element method (FEM) based numerical simulation of a solid isotropic cylindrical structure with wood-like material properties, subjected to a pair of synchronous, identical radial force pulses ‘F’ at its midpoint. This simulation represents the behavior of the cylinder when one end is clamped, restricting both translational and rotational movement, while the other end is free, providing for movement. The depiction details the overall motion of the cylinder, including the distinct pattern for n=2 cross-sectional mode, particularly visible at the surface of the free end, despite the excitation being applied at the midpoint. For the simulation, equal and opposite radial forces are used to enhance the response of the ovalling mode (n=2) and minimize the appearance of extensional modes of odd order (n=3, 5, . . . ). However, in the field, only one excitation force is needed with the in-situ test equipment.

The system and methods of the present disclosure take advantage of the observation that the resonant frequency of the radial extension mode of second order, the ovalling mode, in a round cylinder, depends on the transversal size of the cylinder and on whether it is solid or hollow. Typically, for building elements the resonant frequency takes values less than 2000 Hz and is dependent on the strength condition of the test specimen. A predictable shift in the magnitude of these resonant frequencies towards lower values occurs as the condition of the piece under test deteriorates due to a reduced stiffness resulting from the activity of strength-weakening factors like rust in metals, corrosion in reinforced concrete or decay fungi and insects in wood. The relative shift in the magnitude of the resonant frequencies of the ovalling mode is directly related to the extent of material strength deterioration. For materials with homogeneous and isotropic physical characteristics such as metals, a mathematical model for the exact expression of this relative change may be determined. However, for materials with varying characteristics such as wood, it is relatively hard to formulate a mathematical model due to the wide variety of wood species and resulting from their growth under widely varying climate conditions and ground types.

The resonant frequency of the ovalling mode of the specimen under investigation can be determined through a measurement of its surface vibrations by means of the dual piezoelectric sensor arrangement 100 using the piezoelectric wires 118, 168. Each of the piezoelectric wires 118, 168 are stretched and attached to the ends of two metallic arms of the two radially perpendicularly attached H-shaped calipers 102, 152, the two other ends of which are attached immobilized on the cylinder at two diametrically opposed positions. In the laboratory, setting the test piece under vibration can be made by attaching an electro-dynamic shaker while on the field this may be made through a stroke from a hammer or similar device. The analog signal collected by the dual piezoelectric sensor arrangement 100 is then conveyed to the measurement unit 304 to be digitized for processing and analysis. The processing includes submitting the digitized signal to a Fast discrete Fourier Transform, and from the amplitude of which the resonant frequencies may be determined. Alternatively, the analog vibration signal can be stored on a tape or on a digital medium to be replayed for processing and analysis at a later opportunity.

The tension of the piezoelectric wires 118, 168 of the two H-shaped calipers 102, 152 after installation on the cylindrical wire may be calibrated by hanging a weight at the center of the wires and measuring the changes in height due to the weight. Alternatively, the installed H-shaped caliper 102, 152 may be calibrated by analyzing the application of a precise force by the transducer upon the cylinder versus the amplitude of the received signal. The tensions in the piezoelectric wires 118, 168 are directly related to the amplitude of the received signal through the two-port signal subtractor. Reference can be made to the database 412 or to a handheld chart (in the field) to determine when the amplitude of the received signal is of sufficient magnitude for accurate testing.

In order to differentiate between the various vibration modes of the cylindrical structure under test, and more specifically to isolate the ovalling mode from the overall frequency response, use is made of the dual piezoelectric sensor arrangement 100 with the piezoelectric wires 118, 168 attached after stretching it between two points on the cylinder positioned diametrically on the surface of cylinder. In this respect, the surface vibrations on these positions are in phase for the ovalling mode of vibration, or any other circumferential mode of even order, i.e. the vibrations at these two positions are simultaneously at the same amplitude, for instance at a maximum of vibration, or at a minimum vibration at an odd number of half periods later. The period of vibration is simply the inverse of the resonant frequency.

The present disclosure provides an accurate, effective, and relatively inexpensive technique for inspecting building elements of cylindrical shape, and the corresponding procedure for analysis and for giving the final assessment of the health status of the tested specimen. A portable apparatus can also be presented for this end, which consists of a laptop computer and the hardware/software to be used for the digital conversion and analysis of the analog signal recorded from the specimen under inspection. The application of the present disclosure can be made to cylindrical specimens of any solid material, either filled or hollow. Examples of elements to which the technique can be applied are construction columns, pillars, tree trunks, logs, and poles of circular cylindrical shape. The present disclosure provides for the detection of defects, either structural or resulting from a strength weakening process operating within the material, for elements of cylindrical shape.

A first embodiment describes a dual piezoelectric wire sensor system 300 for non-destructive testing of a cylindrical structure, comprising a first H-shaped caliper 102 configured to attach to the cylindrical structure at a first radial position ‘R1’; a second H-shaped caliper 152 configured to attach to the cylindrical structure at a second radial position ‘R2’ located ninety degrees from the first radial position ‘R1’; wherein each H-shaped caliper 102, 152 comprises a first arm 104, 154, a second arm 106, 156 and a crossbar 108, 158 connected to and perpendicular to the first arm 104, 154 and the second arm 106, 156; a first caliper connector 110, 160 located near a first end 104a, 154a of the first arm 104, 154; a second caliper connector 112, 162 located near a first end 106a, 156a of the second arm 106, 156; a first wire connector 114, 164 located near a second end 104b, 154b of the first arm 104, 154; a second wire connector 116, 166 located near a second end 106b, 156b of the second arm 106, 156; a piezoelectric wire 118, 168 connected to the first wire connector 114, 164 and the second wire connector 116, 166, wherein the piezoelectric wire 118, 168 is stretched between the first wire connector 114, 164 and the second wire connector 116, 166; and an electrical terminal 120, 170 connected to the piezoelectric wire 118, 168 at the second wire connector 116, 166 of each H-shaped caliper 102, 152, wherein the electrical terminal 120, 170 is configured to receive an electrical signal ‘S1’, ‘S2’ generated by the piezoelectric wire 118, 168 in response to expansion and contraction of a distance between the second end 104b, 154b of the first arm 104, 154 and the second end 106b, 156b of the second arm 106, 156 as a result of vibrations induced in the cylindrical structure; a two-port signal subtractor 306 having a first port 306a connected to the electrical terminal 120 of the first H-shaped caliper 102 and a second port 306b connected to the electrical terminal 170 of the second H-shaped caliper 152, wherein the two-port signal subtractor 306 is configured to subtract the electrical signals ‘S1’ of the first H-shaped caliper 102 from the electrical signals ‘S2’ of the second H-shaped caliper 152 and generate a difference signal ‘S3’; and a measurement unit 304 connected to the two-port signal subtractor 306, wherein the measurement unit 304 is configured to receive the difference signal ‘S3’, amplify and perform a frequency analysis of the difference signal ‘S3’, identify a resonant frequency of an ovalling mode of the difference signal ‘S3’ and identify a stiffness value of the cylindrical structure based on the resonant frequency of the ovalling mode.

In an aspect, the dual piezoelectric wire sensor system 300 includes the first caliper connector 110, 160 and the second caliper connector 112, 162 of each H-shaped caliper 102, 152 which are connected to the cylindrical structure at positions in which the first end 104a, 154a of the first arm 104, 154 and the first end 106a, 156a of the second arm 106, 156 are diametrically opposed across the cylindrical structure.

In an aspect, the dual piezoelectric wire sensor system 300 includes each H-shaped caliper 102, 152 which has a length ‘L2’, ‘L4’ of each arm 104, 106, 154, 156 from the crossbar 108, 158 to each second end 104b, 106b, 154b, 156b which is larger than a length ‘L1’, ‘L3’ from each caliper connector 110, 112, 150, 152 to the crossbar 108, 158, wherein the length ‘L2’, ‘L4’ from the crossbar 108, 158 to each second end 104b, 106b, 154b, 156b is configured to amplify the vibrations in the piezoelectric wire 118, 168 by increasing the expansion and contraction of the distance between the first end 104a, 154a of the first arm 104, 154 and the first end 106a, 156a of the second arm 106, 156.

In an aspect, the dual piezoelectric wire sensor system 300 provides that a length ‘H’ of the crossbar 108, 158 of each H-shaped caliper 102, 152 is equal to a diameter ‘H’ of the cylindrical structure.

In an aspect, the dual piezoelectric wire sensor system 300 includes an adjustable clamp 122, 172 connected to the first arm 104, 154 of each H-shaped caliper 102, 152 at a position in which a first end 108a, 158a of the crossbar 108, 158 intersects the first arm 104, 154, wherein the adjustable clamp 122, 172 is configured to attach the first end 108a, 158a of the crossbar 108, 158 to the first arm 104, 154 at a position on the crossbar 108, 158 in which a length ‘H’ of the crossbar 108, 158 is equal to a diameter ‘H’ of the cylindrical structure.

In an aspect, the dual piezoelectric wire sensor system 300 provides that the length ‘L2’, ‘L4’ of each arm 104, 106, 154, 156 of each H-shaped caliper 102, 152 from the crossbar 108, 158 to each second end 104b, 106b, 154b, 156b is about two times the length ‘L1’, ‘L3’ from each caliper connector 110, 112, 150, 152 to the crossbar 108, 158.

In an aspect, the dual piezoelectric wire sensor system 300 includes the first arm 104, 154, the second arm 106, 156 and the crossbar 108, 158 are formed of metal.

In an aspect, the dual piezoelectric wire sensor system 300 includes the measurement unit 304 which further comprises a signal amplifier 402 configured to amplify the difference signal ‘S3’ and generate an amplified difference signal.

In an aspect, the dual piezoelectric wire sensor system 300 includes the measurement unit 304 which further comprises an analog to digital converter 406 configured to transform the amplified difference signal to a digital signal.

In an aspect, the dual piezoelectric wire sensor system 300 includes the measurement unit 304 which further comprises a frequency analyzer 408 configured to perform the frequency analysis of the digital signal by using a fast discrete Fourier transform to generate a frequency spectrum of the digital signal.

In an aspect, the dual piezoelectric wire sensor system 300 includes the frequency spectrum which is configured to range from 20 to 2000 Hz.

In an aspect, the dual piezoelectric wire sensor system 300 includes the measurement unit 304 which further comprises a computing device 410 having electrical circuitry, a memory storing program instructions, and at least one processor configured to execute the program instructions to perform a frequency response analysis to identify the resonant frequencies and amplitudes of the resonant frequencies of the digital signal and identify an ovalling mode of the resonant frequencies and amplitudes of the digital signal.

In an aspect, the dual piezoelectric wire sensor system 300 includes the computing device 410 which further comprises a database 412 stored in the memory, wherein the database 412 includes database records of ovalling modes related to the stiffness value of cylindrical structures based on the diameter ‘H’ and a material of the cylindrical structure; a search engine 414 configured to search the database 412 to match the ovalling mode of the digital signal to an ovalling mode recorded in the database 412; a display 418; and an analysis unit 416 configured to determine a soundness score of the cylindrical structure based on the stiffness value and output the soundness score onto the display 418.

In an aspect, the dual piezoelectric wire sensor system 300 includes the computing device 410 which is configured to identify the resonant frequency of the ovalling mode based on a second harmonic of the difference signal ‘S3’.

In an aspect, the dual piezoelectric wire sensor system 300 includes the measurement unit 304 which further comprises a recorder 404 configured to record the amplified difference signal for off-site processing and generate a time stamp of a sampling time of the electrical signal ‘S1’, ‘S2’.

In an aspect, the dual piezoelectric wire sensor system 300 includes a hammer 302 configured to generate an impulse force ‘F’ at a radial direction on the cylindrical structure at one of a position located at in a range of about 10 cm to about 16 cm above the first and second radial positions ‘R1’, ‘R2’ and a position located at in a range of about 10 cm to about 16 cm below the first and second radial positions ‘R1’, ‘R2’, wherein the impulse force ‘F’ is configured to induce the vibrations in the cylindrical structure.

In an aspect, the dual piezoelectric wire sensor system 300 includes an electrodynamic shaker 302 located on the cylindrical structure at one of a position located at in a range of about 10 cm to about 16 cm above the first and second radial positions ‘R1’, ‘R2’ and a position located at in a range of about 10 cm to about 16 cm below the first and second radial positions ‘R1’, ‘R2’, wherein the electrodynamic shaker 302 is configured to generate an impulse force ‘F’ in a radial direction of the cylindrical structure which induces the vibrations in the cylindrical structure.

A second embodiment describes a method 500 for non-destructive testing of soundness of a cylindrical structure with a dual piezoelectric wire sensor system 300, comprising attaching a first H-shaped caliper 102 to the cylindrical structure at a first radial position ‘R1’; attaching a second H-shaped caliper 152 to the cylindrical structure at a second radial position ‘R2’ located ninety degrees from the first radial position ‘R1’; wherein each H-shaped caliper 102, 152 comprises a first arm 104, 154, a second arm 106, 156 and a crossbar 108, 158 connected to and perpendicular to the first arm 104, 154 and the second arm 106, 156; a first caliper connector 110, 160 located near a first end 104a, 154a of the first arm 104, 154; a second caliper connector 112, 162 located near a first end 106a, 156a of the second arm 106, 156; a first wire connector 114, 164 located near a second end 104b, 154b of the first arm 104, 154; a second wire connector 116, 166 located near a second end 106b, 156b of the second arm 106, 156; a piezoelectric wire 118, 168 connected to the first wire connector 114, 164 and the second wire connector 116, 166, wherein the piezoelectric wire 118, 168 is stretched between the first wire connector 114, 164 and the second wire connector 116, 166; an electrical terminal 120, 170 connected to the piezoelectric wire 118, 168 at the second wire connector 116, 166 of each H-shaped caliper 102, 152; inducing vibrations within the cylindrical structure by applying an impulse force ‘F’ to the cylindrical structure in a radial direction at one of a position located at in a range of about 10 cm to about 16 cm above the first and second radial positions ‘R1’, ‘R2’ and a position located at in a range of about 10 cm to about 16 cm below the first and second radial positions ‘R1’, ‘R2’; receiving, by the electrical terminal 120, 170, an electrical signal ‘S1’, ‘S2’ generated by the piezoelectric wire 118, 168 in response to expansion and contraction of a distance between the second end 104b, 154b of the first arm 104, 154 and the second end 106b, 156b of the second arm 106, 156 as a result of the vibrations; receiving, by a two-port signal subtractor 306 having a first port 306a connected to the electrical terminal 120 of the first H-shaped caliper 102 and a second port 306b connected to the electrical terminal 170 of the second H-shaped caliper 152, the electrical signals ‘S1’, ‘S2’ at the first port 306a and the second port 306b; subtracting, by the two-port signal subtractor 306, the electrical signals ‘S1’ and ‘S2’; generating, by the two-port signal subtractor 306, a difference signal ‘S3’; receiving, by a measurement unit 304 connected to the two-port signal subtractor 306, the difference signal ‘S3’; performing, by the measurement unit 304, a frequency analysis of the difference signal ‘S3’; identifying by the measurement unit 304, a resonant frequency of an ovalling mode of the difference signal ‘S3’; and identifying by the measurement unit 304, a stiffness value of the cylindrical structure based on the resonant frequency of the ovalling mode.

In an aspect, the method 500 includes amplifying, by a signal amplifier 402 of the measurement unit 304, the difference signal ‘S3’ and generating an amplified difference signal; recording, on a recorder 404, the amplified difference signal; transforming, by an analog to digital converter 406 of the measurement unit 304, the amplified difference signal to a digital signal; performing, by a frequency analyzer 408 of the measurement unit 304, the frequency analysis of the digital signal by a fast discrete Fourier transform to generate a frequency spectrum of the digital signal; performing, by a computing device 410 having electrical circuitry, a memory storing program instructions, and at least one processor configured to execute the program instructions, a frequency response analysis identifying the resonant frequencies and amplitudes of the resonant frequencies of the digital signal and identifying an ovalling mode of the resonant frequencies and amplitudes of the digital signal; performing, by the computing device 410, a search of a database 412 storing database records of ovalling modes related to the stiffness value of cylindrical structures based on the diameter ‘H’ and a material of the cylindrical structure, and matching the ovalling mode of the digital signal to an ovalling mode recorded in the database 412; determining, by the computing device 410, a soundness score of the cylindrical structure based on the stiffness value; and outputting, by the computing device 410, the soundness score onto a display 418 of the computing device 410.

In an aspect, the method 500 includes amplifying, by a signal amplifier 402 of the measurement unit 304, the difference signal ‘S3’ and generating an amplified difference signal; recording, on a recorder 404, the amplified difference signal; transforming, by an analog to digital converter 406 of the measurement unit 304, the amplified difference signal to a digital signal; performing, by a frequency analyzer 408 of the measurement unit 304, the frequency analysis of the digital signal by a fast discrete Fourier transform to generate a frequency spectrum of the digital signal; performing, by a computing device 410 having electrical circuitry, a memory storing program instructions, and at least one processor configured to execute the program instructions, a frequency response analysis identifying the resonant frequencies and amplitudes of the resonant frequencies of the digital signal and identifying an ovalling mode of the resonant frequencies and amplitudes of the digital signal; generating, by the computing device 410, a mathematical model of the cylindrical structure; modelling, by the computing device 410, the resonant frequencies and amplitudes of the ovalling mode as a function of diameter ‘H’ and a corresponding stiffness value of the cylindrical structure; matching, by the computing device 410, the resonant frequency and amplitude of the ovalling mode of the digital signal to an ovalling mode of the mathematical model for the corresponding diameter ‘H’ of the cylindrical structure; determining the stiffness value of the cylindrical structure based on the matched resonant frequency and amplitude of the ovalling mode of the digital signal; determining, by the computing device 410, a soundness score of the cylindrical structure based on the stiffness value; and outputting, by the computing device 410, the soundness score onto a display 418 of the computing device 410.

Next, further details of the hardware description of the computing environment according to exemplary embodiments are described with reference to FIG. 9. In FIG. 9, a controller 900 is described embodying the measurement unit 304, and specifically the computing device 410 therein, in which the controller 900 is a computing device which includes a CPU 901 which performs the processes described above/below. The process data and instructions may be stored in memory 902. These processes and instructions may also be stored on a storage medium disk 904 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 901, 903 and an operating system such as Microsoft Windows 7, Microsoft Windows 8, Microsoft Windows 10, UNIX, Solaris, LINUX, Apple MAC-OS, and other systems known to those skilled in the art.

The hardware elements in order to achieve the computing device may be realized by various circuitry elements, known to those skilled in the art. For example, CPU 901 or CPU 903 may be a Xenon or Core processor from Intel of America or an Opteron processor from AMD of America, or may be other processor types that would be recognized by one of ordinary skill in the art. Alternatively, the CPU 901, 903 may be implemented on an FPGA, ASIC, PLD or using discrete logic circuits, as one of ordinary skill in the art would recognize. Further, CPU 901, 903 may be implemented as multiple processors cooperatively working in parallel to perform the instructions of the inventive processes described above.

The computing device in FIG. 9 also includes a network controller 906, such as an Intel Ethernet PRO network interface card from Intel Corporation of America, for interfacing with network 960. As can be appreciated, the network 960 can be a public network, such as the Internet, or a private network such as an LAN or WAN network, or any combination thereof and can also include PSTN or ISDN sub-networks. The network 960 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 908, such as a NVIDIA Geforce GTX or Quadro graphics adaptor from NVIDIA Corporation of America for interfacing with display 910, such as a Hewlett Packard HPL2445w LCD monitor. A general purpose I/O interface 912 interfaces with a keyboard and/or mouse 914 as well as a touch screen panel 916 on or separate from display 910. General purpose I/O interface also connects to a variety of peripherals 918 including printers and scanners, such as an OfficeJet or DeskJet from Hewlett Packard.

A sound controller 920 is also provided in the computing device such as Sound Blaster X-Fi Titanium from Creative, to interface with speakers/microphone 922 thereby providing sounds and/or music.

The general purpose storage controller 924 connects the storage medium disk 904 with communication bus 926, which may be an ISA, EISA, VESA, PCI, or similar, for interconnecting all of the components of the computing device. A description of the general features and functionality of the display 910, keyboard and/or mouse 914, as well as the display controller 908, storage controller 924, network controller 906, sound controller 920, and general purpose I/O interface 912 is omitted herein for brevity as these features are known.

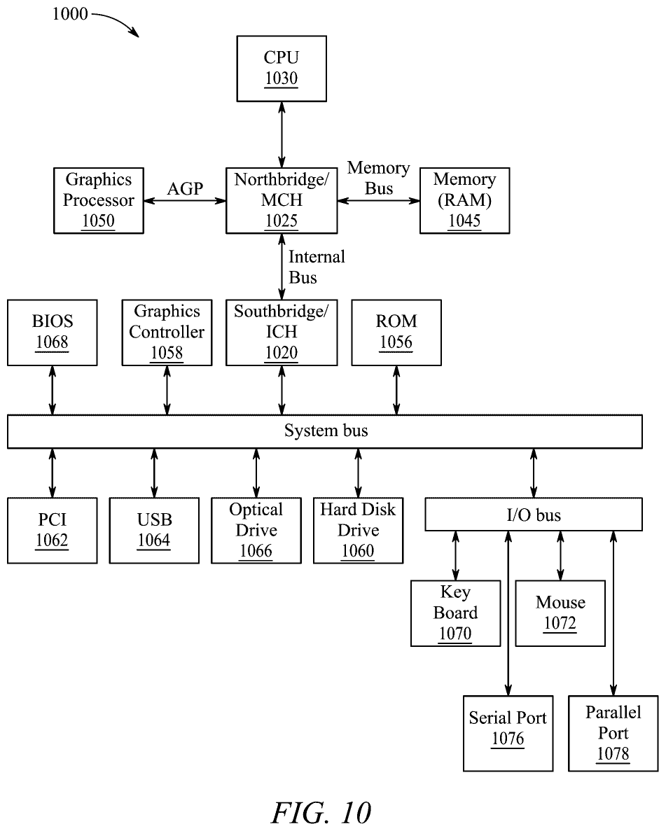

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 10.

FIG. 10 shows a schematic diagram of a data processing system, according to certain embodiments, for performing the functions of the exemplary embodiments. The data processing system is an example of a computer in which code or instructions implementing the processes of the illustrative embodiments may be located.

In FIG. 10, data processing system 1000 employs a hub architecture including a north bridge and memory controller hub (NB/MCH) 1025 and a south bridge and input/output (I/O) controller hub (SB/ICH) 1020. The central processing unit (CPU) 1030 is connected to NB/MCH 1025. The NB/MCH 1025 also connects to the memory 1045 via a memory bus and connects to the graphics processor 1050 via an accelerated graphics port (AGP). The NB/MCH 1025 also connects to the SB/ICH 1020 via an internal bus (e.g., a unified media interface or a direct media interface). The CPU Processing unit 1030 may contain one or more processors and even may be implemented using one or more heterogeneous processor systems.

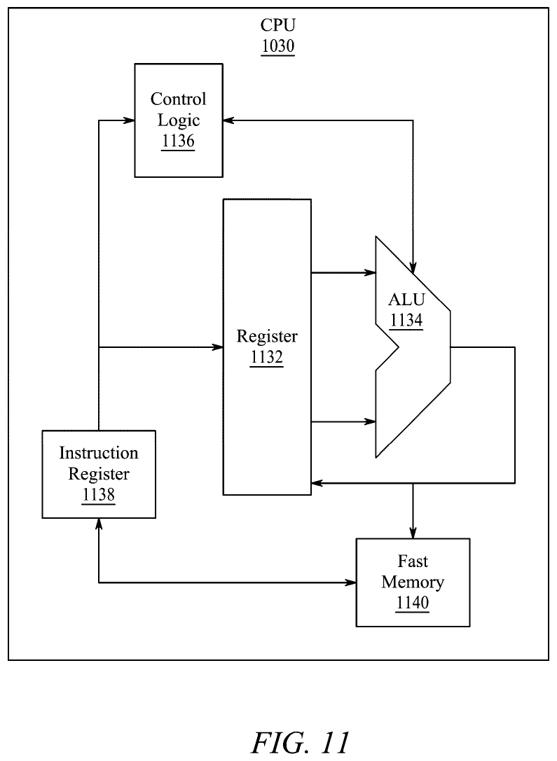

For example, FIG. 11 shows one implementation of CPU 1030. In one implementation, the instruction register 1138 retrieves instructions from the fast memory 1140. At least part of these instructions are fetched from the instruction register 1138 by the control logic 1136 and interpreted according to the instruction set architecture of the CPU 1030. Part of the instructions can also be directed to the register 1132. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1134 that loads values from the register 1132 and performs logical and mathematical operations on the loaded values according to the instructions. The results from these operations can be feedback into the register and/or stored in the fast memory 1140. According to certain implementations, the instruction set architecture of the CPU 1030 can use a reduced instruction set architecture, a complex instruction set architecture, a vector processor architecture, a very large instruction word architecture. Furthermore, the CPU 1030 can be based on the Von Neuman model or the Harvard model. The CPU 1030 can be a digital signal processor, an FPGA, an ASIC, a PLA, a PLD, or a CPLD. Further, the CPU 1030 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 10, the data processing system 1000 can include that the SB/ICH 1020 is coupled through a system bus to an I/O Bus, a read only memory (ROM) 1056, universal serial bus (USB) port 1064, a flash binary input/output system (BIOS) 1068, and a graphics controller 1058. PCI/PCIe devices can also be coupled to SB/ICH 1088 through a PCI bus 1062.

The PCI devices may include, for example, Ethernet adapters, add-in cards, and PC cards for notebook computers. The Hard disk drive 1060 and CD-ROM 1066 can use, for example, an integrated drive electronics (IDE) or serial advanced technology attachment (SATA) interface. In one implementation the I/O bus can include a super I/O (SIO) device.

Further, the hard disk drive (HDD) 1060 and optical drive 1066 can also be coupled to the SB/ICH 1020 through a system bus. In one implementation, a keyboard 1070, a mouse 1072, a parallel port 1078, and a serial port 1076 can be connected to the system bus through the I/O bus. Other peripherals and devices that can be connected to the SB/ICH 1020 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

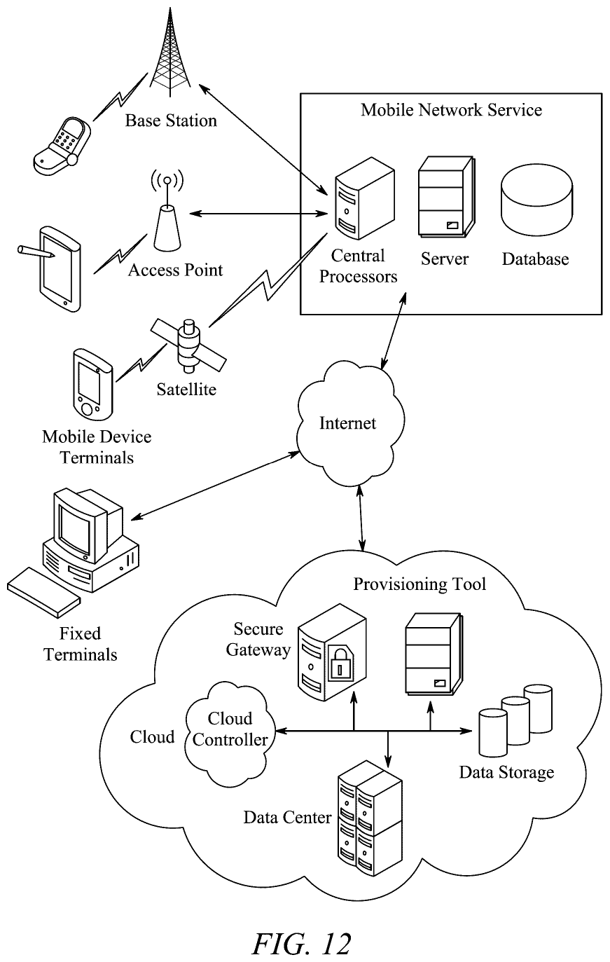

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 12, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A dual piezoelectric wire sensor system for non-destructive testing of a cylindrical structure, comprising:
a first H-shaped caliper configured to attach to the cylindrical structure at a first radial position;
a second H-shaped caliper configured to attach to the cylindrical structure at a second radial position located ninety degrees from the first radial position;
wherein each H-shaped caliper comprises:
a first arm, a second arm and a crossbar connected to and perpendicular to the first arm and the second arm;
a first caliper connector located near a first end of the first arm;
a second caliper connector located near a first end of the second arm;
a first wire connector located near a second end of the first arm;
a second wire connector located near a second end of the second arm;
a piezoelectric wire connected to the first wire connector and the second wire connector, wherein the piezoelectric wire is stretched between the first wire connector and the second wire connector; and
an electrical terminal connected to the piezoelectric wire at the second wire connector of each H-shaped caliper,
wherein the electrical terminal is configured to receive an electrical signal generated by the piezoelectric wire in response to expansion and contraction of a distance between the second end of the first arm and the second end of the second arm as a result of vibrations induced in the cylindrical structure;
a two-port signal subtractor having a first port connected to the electrical terminal of the first H-shaped caliper and a second port connected to the electrical terminal of the second H-shaped caliper, wherein the two-port signal subtractor is configured to subtract the electrical signals of the first H-shaped caliper from the electrical signals of the second H-shaped caliper and generate a difference signal; and
a measurement unit connected to the two-port signal subtractor, wherein the measurement unit is configured to receive the difference signal, amplify the difference signal, perform a frequency analysis of the difference signal, identify a resonant frequency of an ovalling mode of the difference signal and identify a stiffness value of the cylindrical structure based on the resonant frequency of the ovalling mode.

2. The dual piezoelectric wire sensor system of claim 1, wherein the first caliper connector and the second caliper connector of each H-shaped caliper are connected to the cylindrical structure at positions in which the first end of the first arm and the first end of the second arm are diametrically opposed across the cylindrical structure.

3. The dual piezoelectric wire sensor system of claim 2, wherein each H-shaped caliper has a length of each arm from the crossbar to each second end which is larger than a length from each caliper connector to the crossbar, wherein the length from the crossbar to each second end is configured to amplify the vibrations in the piezoelectric wire by increasing the expansion and contraction of the distance between the first end of the first arm and the first end of the second arm.

4. The dual piezoelectric wire sensor system of claim 3, wherein a length of the crossbar of each H-shaped caliper is equal to a diameter of the cylindrical structure.

5. The dual piezoelectric wire sensor system of claim 3, further comprising:
an adjustable clamp connected to the first arm of each H-shaped caliper at a position in which a first end of the crossbar intersects the first arm, wherein the adjustable clamp is configured to attach the first end of the crossbar to the first arm at a position on the crossbar in which a length of the crossbar is equal to a diameter of the cylindrical structure.

6. The dual piezoelectric wire sensor system of claim 3, wherein the length of each arm of each H-shaped caliper from the crossbar to each second end is about two times the length from each caliper connector to the crossbar.

7. The dual piezoelectric wire sensor system of claim 1, wherein the first arm, the second arm and the crossbar are formed of metal.

8. The dual piezoelectric wire sensor system of claim 1, wherein the measurement unit further comprises a signal amplifier configured to amplify the difference signal and generate an amplified difference signal.

9. The dual piezoelectric wire sensor system of claim 8, wherein the measurement unit further comprises an analog to digital converter configured to transform the amplified difference signal to a digital signal.

10. The dual piezoelectric wire sensor system of claim 9, wherein the measurement unit further comprises a frequency analyzer configured to perform the frequency analysis of the digital signal by using a fast discrete Fourier transform to generate a frequency spectrum of the digital signal.

11. The dual piezoelectric wire sensor system of claim 10, wherein the frequency spectrum is configured to range from 20 to 2000 Hz.

12. The dual piezoelectric wire sensor system of claim 10, wherein the measurement unit further comprises a computing device having electrical circuitry, a memory storing program instructions, and at least one processor configured to execute the program instructions to perform a frequency response analysis to identify the resonant frequencies and amplitudes of the resonant frequencies of the digital signal and identify an ovalling mode of the resonant frequencies and amplitudes of the digital signal.

13. The dual piezoelectric wire sensor system of claim 12, wherein the computing device further comprises:
a database stored in the memory, wherein the database includes database records of ovalling modes related to the stiffness value of cylindrical structures based on the diameter and a material of the cylindrical structure;
a search engine configured to search the database to match the ovalling mode of the digital signal to an ovalling mode recorded in the database;
a display; and
an analysis unit configured to determine a soundness score of the cylindrical structure based on the stiffness value and output the soundness score onto the display.

14. The dual piezoelectric wire sensor system of claim 13, wherein the computing device is configured to identify the resonant frequency of the ovalling mode based on a second harmonic of the difference signal.

15. The dual piezoelectric wire sensor system of claim 8, wherein the measurement unit further comprises a recorder configured to record the amplified difference signal for off-site processing and generate a time stamp of a sampling time of the electrical signal.

16. The dual piezoelectric wire sensor system of claim 1, further comprising:
a hammer configured to generate an impulse force at a radial direction on the cylindrical structure at one of a position located at in a range of about 10 cm to about 16 cm above the first and second radial positions and a position located at in a range of about 10 cm to about 16 cm below the first and second radial positions, wherein the impulse force is configured to induce the vibrations in the cylindrical structure.

17. The dual piezoelectric wire sensor system of claim 1, further comprising:
an electrodynamic shaker located on the cylindrical structure at one of a position located at in a range of about 10 cm to about 16 cm above the first and second radial positions and a position located at in a range of about 10 cm to about 16 cm below the first and second radial positions, wherein the electrodynamic shaker is configured to generate an impulse force in a radial direction of the cylindrical structure which induces the vibrations in the cylindrical structure.

18. A method for non-destructive testing of soundness of a cylindrical structure with a dual piezoelectric wire sensor system, comprising:
attaching a first H-shaped caliper to the cylindrical structure at a first radial position;
attaching a second H-shaped caliper to the cylindrical structure at a second radial position located ninety degrees from the first radial position;
wherein each H-shaped caliper comprises:
a first arm, a second arm and a crossbar connected to and perpendicular to the first arm and the second arm;
a first caliper connector located near a first end of the first arm;
a second caliper connector located near a first end of the second arm;
a first wire connector located near a second end of the first arm;
a second wire connector located near a second end of the second arm;
a piezoelectric wire connected to the first wire connector and the second wire connector, wherein the piezoelectric wire is stretched between the first wire connector and the second wire connector;
an electrical terminal connected to the piezoelectric wire at the second wire connector of each H-shaped caliper;
inducing vibrations within the cylindrical structure by applying an impulse force to the cylindrical structure in a radial direction at one of a position located at in a range of about 10 cm to about 16 cm above the first and second radial positions and a position located at in a range of about 10 cm to about 16 cm below the first and second radial positions;
receiving, by the electrical terminal, an electrical signal generated by the piezoelectric wire in response to expansion and contraction of a distance between the second end of the first arm and the second end of the second arm as a result of the vibrations;
receiving, by a two-port signal subtractor having a first port connected to the electrical terminal of the first H-shaped caliper and a second port connected to the electrical terminal of the second H-shaped caliper, the electrical signals at the first port and the second port;
subtracting, by the two-port signal subtractor, the electrical signals;
generating, by the two-port signal subtractor, a difference signal;
receiving, by a measurement unit connected to the two-port signal subtractor, the difference signal;
performing, by the measurement unit, a frequency analysis of the difference signal;
identifying by the measurement unit, a resonant frequency of an ovalling mode of the difference signal; and
identifying by the measurement unit, a stiffness value of the cylindrical structure based on the resonant frequency of the ovalling mode.

19. The method of claim 18, further comprising:
amplifying, by a signal amplifier of the measurement unit, the difference signal and generating an amplified difference signal;
recording, on a recorder, the amplified difference signal;
transforming, by an analog to digital converter of the measurement unit, the amplified difference signal to a digital signal;
performing, by a frequency analyzer of the measurement unit, the frequency analysis of the digital signal by a fast discrete Fourier transform to generate a frequency spectrum of the digital signal;
performing, by a computing device having electrical circuitry, a memory storing program instructions, and at least one processor configured to execute the program instructions, a frequency response analysis identifying the resonant frequencies and amplitudes of the resonant frequencies of the digital signal and identifying an ovalling mode of the resonant frequencies and amplitudes of the digital signal;
performing, by the computing device, a search of a database storing database records of ovalling modes related to the stiffness value of cylindrical structures based on the diameter and a material of the cylindrical structure, and matching the ovalling mode of the digital signal to an ovalling mode recorded in the database;
determining, by the computing device, a soundness score of the cylindrical structure based on the stiffness value; and
outputting, by the computing device, the soundness score onto a display of the computing device.

20. The method of claim 18, further comprising:
amplifying, by a signal amplifier of the measurement unit, the difference signal and generating an amplified difference signal;
recording, on a recorder, the amplified difference signal;
transforming, by an analog to digital converter of the measurement unit, the amplified difference signal to a digital signal;
performing, by a frequency analyzer of the measurement unit, the frequency analysis of the digital signal by a fast discrete Fourier transform to generate a frequency spectrum of the digital signal;
performing, by a computing device having electrical circuitry, a memory storing program instructions, and at least one processor configured to execute the program instructions, a frequency response analysis identifying the resonant frequencies and amplitudes of the resonant frequencies of the digital signal and identifying an ovalling mode of the resonant frequencies and amplitudes of the digital signal;
generating, by the computing device, a mathematical model of the cylindrical structure;
modelling, by the computing device, the resonant frequencies and amplitudes of the ovalling mode as a function of diameter and a corresponding stiffness value of the cylindrical structure;
matching, by the computing device, the resonant frequency and amplitude of the ovalling mode of the digital signal to an ovalling mode of the mathematical model for the corresponding diameter of the cylindrical structure;
determining the stiffness value of the cylindrical structure based on the matched resonant frequency and amplitude of the ovalling mode of the digital signal;
determining, by the computing device, a soundness score of the cylindrical structure based on the stiffness value; and
outputting, by the computing device, the soundness score onto a display of the computing device.
